(19) United States
(12) Patent Application Publication
(10) Pub. No.: US 2019/0213791 A1
(43) Pub. Date: Jul. 11, 2019

(54) INFORMATION PROCESSING APPARATUS RELATING TO GENERATION OF VIRTUAL VIEWPOINT IMAGE, METHOD AND STORAGE MEDIUM

(71) Applicant: CANON KABUSHIKI KAISHA, Tokyo (JP)

(72) Inventors: Takashi Hanamoto, Yokohama-shi (JP); Tomoyori Iwao, Tokyo (JP)

(21) Appl. No.: 16/354,980

(22) Filed: Mar. 15, 2019

Related U.S. Application Data
(63) Continuation of application No. PCT/JP2017/028876, filed on Aug. 9, 2017.

(30) Foreign Application Priority Data
Sep. 15, 2016 (JP) 2016-180527

(51) Int. Cl. G06T 19/00; G06T 7/73; G06K 9/00; G06T 7/593

(52) U.S. Cl. CPC G06T 19/003; G06T 7/596; G06K 9/00724; G06T 7/73

(57) ABSTRACT

An object is to make it possible to arbitrarily set a height and a moving speed of a virtual camera also and to obtain a virtual viewpoint video image by an easy operation in a short time. The information processing apparatus is an information processing apparatus that sets a movement path of a virtual viewpoint relating to a virtual viewpoint image generated based on a plurality of images obtained by a plurality of cameras, and includes: a specification unit configured to specify a movement path of a virtual viewpoint; a display control unit configured to display a plurality of virtual viewpoint images in accordance with the movement path specified by the specification unit on a display screen; a reception unit configured to receive an operation for at least one of the plurality of virtual viewpoint images displayed on the display screen; and a change unit configured to change the movement path specified by the specification unit in accordance with the operation received by the reception unit.

### CROSS-REFERENCE TO RELATED APPLICATIONS

This application is a Continuation of International Patent Application No. PCT/JP2017/028876, filed Aug. 9, 2017, which claims the benefit of Japanese Patent Application No. 2016-180527, filed Sep. 15, 2016, both of which are hereby incorporated by reference herein in their entirety.

### BACKGROUND OF THE INVENTION

### Field of the Invention

The present invention relates to a technique to set a virtual camera path at the time of generation of a virtual viewpoint video image.

### Description of the Related Art

As a technique to generate a video image from a camera (virtual camera) that does not exist actually but is arranged virtually within a three-dimensional space by using video images captured by a plurality of real cameras, there is a virtual viewpoint video image technique. In order to obtain a virtual viewpoint video image, it is necessary to set a virtual camera path and the like, and in order to do this, it is necessary to appropriately control parameters, such as a position (x, y, z), a rotation angle (φ), an angle of view (θ), and a gaze point (xo, yo, zo), of a virtual camera along a time axis (t). In order to appropriately set and control those many parameters, skill is required and it is difficult for an ordinary person to perform the operation, and only a skilled and experienced person with expertise can perform the operation. Regarding this point, Patent Document 1 has disclosed a method of setting parameters of a virtual camera based on a plan diagram (for example, a floor plan within an art museum) in a case where a target three-dimensional space is viewed from above and checking a virtual viewpoint video image at a specified position.

### CITATION LIST

### Patent Literature

PTL 1 Japanese Patent Laid-Open No. 2013-90257

### SUMMARY OF THE INVENTION

However, with the method of Patent Document 1 described above, it is necessary to repeatedly perform the series of operation several times, such as parameter setting of a virtual camera on a plan diagram, checking of all sequences of a virtual viewpoint video image in accordance with the setting, and modification of parameters (re-setting), and therefore, there is such a problem that the work time lengthens. Further, with this method, originally, it is not possible to set the height or the moving speed of a virtual camera, and therefore, it is not possible to obtain a virtual viewpoint video image for which these parameters are changed.

The information processing apparatus according to the present invention is an information processing apparatus that sets a movement path of a virtual viewpoint relating to a virtual viewpoint image generated based on a plurality of images obtained by a plurality of cameras, and includes: a specification unit configured to specify a movement path of a virtual viewpoint; a display control unit configured to display a plurality of virtual viewpoint images in accordance with a movement path specified by the specification unit on a display screen; a reception unit configured to receive an operation for at least one of the plurality of virtual viewpoint images displayed on the display screen; and a change unit configured to change the movement path specified by the specification unit in accordance with the operation received by the reception unit.

### Effect of the invention

According to the present invention, it is possible to arbitrarily set the height and the moving speed of a virtual camera also and to obtain a virtual viewpoint video image by an easy operation.

Further features of the present invention will become apparent from the following description of exemplary embodiments with reference to the attached drawings.

### BRIEF DESCRIPTION OF THE DRAWINGS

FIG. 1 is a diagram showing an example of a configuration of a virtual viewpoint video image system;

FIG. 2 is a diagram showing an arrangement example of each camera configuring a camera group;

FIG. 3A is a diagram showing an example of a GUI screen used at the time of virtual viewpoint video image generation according to a first embodiment;

FIG. 3B is a diagram showing an example of a GUI screen used at the time of virtual viewpoint video image generation according to the first embodiment;

FIG. 4 is a flowchart showing a rough flow of processing to generate a virtual viewpoint video image according to the first embodiment;

FIG. 5 is a flowchart showing details of virtual camera setting processing according to the first embodiment;

FIG. 6A is an example of a static 2D map onto which positions and 3D shapes of an object are projected;

FIG. 6B is an example of results of specifying a gaze point path and a camera path;

FIG. 6C is a diagram showing an example of results of thumbnail arrangement processing;

FIG. 7 is a flowchart showing details of the thumbnail arrangement processing;

FIG. 8A is a diagram explaining a process of the thumbnail arrangement processing;

FIG. 8B is a diagram explaining a process of the thumbnail arrangement processing;

FIG. 8C is a diagram explaining a process of the thumbnail arrangement processing;

FIG. 9 is a flowchart showing details of camera path adjustment processing;

FIG. 10A is a diagram explaining a process of the camera path adjustment processing;

FIG. 10B is a diagram explaining a process of the camera path adjustment processing;

FIG. 10C is a diagram explaining a process of the camera path adjustment processing;

FIG. 11A is a diagram showing a state where a gradation icon is added;

FIG. 11B is a diagram explaining a relationship between each thumbnail image, a moving speed of a virtual camera, and a reproduction time of a virtual viewpoint video image;

FIG. 12 is a flowchart showing details of gaze point path adjustment processing;

FIG. 13A is a diagram explaining a process of the gaze point path adjustment processing;

FIG. 13B is a diagram explaining a process of the gaze point path adjustment processing;

FIG. 13C is a diagram explaining a process of the gaze point path adjustment processing;

FIG. 13D is a diagram explaining a process of the gaze point path adjustment processing;

FIG. 14 is a diagram showing an example of a GUI screen at the time of virtual viewpoint video image generation according to a second embodiment;

FIG. 15 is a flowchart showing a rough flow of processing to generate a virtual viewpoint video image according to the second embodiment;

FIG. 16 is a flowchart showing details of virtual camera setting processing according to the second embodiment;

FIG. 17A is an example of a start frame of a dynamic 2D map;

FIG. 17B is a diagram showing in a time series the way a gaze point path is specified on the dynamic 2D map;

FIG. 17C is a diagram showing in a time series the way a gaze point path is specified on the dynamic 2D map;

FIG. 17D is a diagram showing in a time series the way a gaze point path is specified on the dynamic 2D map;

FIG. 18A is a diagram showing in a time series the way a camera path is specified on the dynamic 2D map after specification of a gaze point path is completed;

FIG. 18B is a diagram showing in a time series the way a camera path is specified on the dynamic 2D map after specification of a gaze point path is completed;

FIG. 18C is a diagram showing in a time series the way a camera path is specified on the dynamic 2D map after specification of a gaze point path is completed;

FIG. 19A is a diagram explaining a difference between modes at the time of specifying a camera path;

FIG. 19B is a diagram explaining a difference between modes at the time of specifying a camera path;

FIG. 20A is a diagram showing an example in which object information is narrowed spatially;

FIG. 20B is a diagram showing an example in which object information is narrowed spatially;

FIG. 21A is a flowchart showing details of gaze point path specification reception processing;

FIG. 21B is a flowchart showing details of the gaze point path specification reception processing;

FIG. 22A is a flowchart showing details of camera path specification reception processing;

FIG. 22B is a flowchart showing details of the camera path specification reception processing; and

FIG. 23 is a flowchart showing details of path adjustment processing.

### DESCRIPTION OF THE EMBODIMENTS

In the following, embodiments of the present invention are explained with reference to the drawings. The following embodiments are not intended to limit the present invention and all combinations of features explained in the present embodiments are not necessarily indispensable to the solution of the present invention. Explanation is given by attaching the same symbol to the same configuration.

### First Embodiment

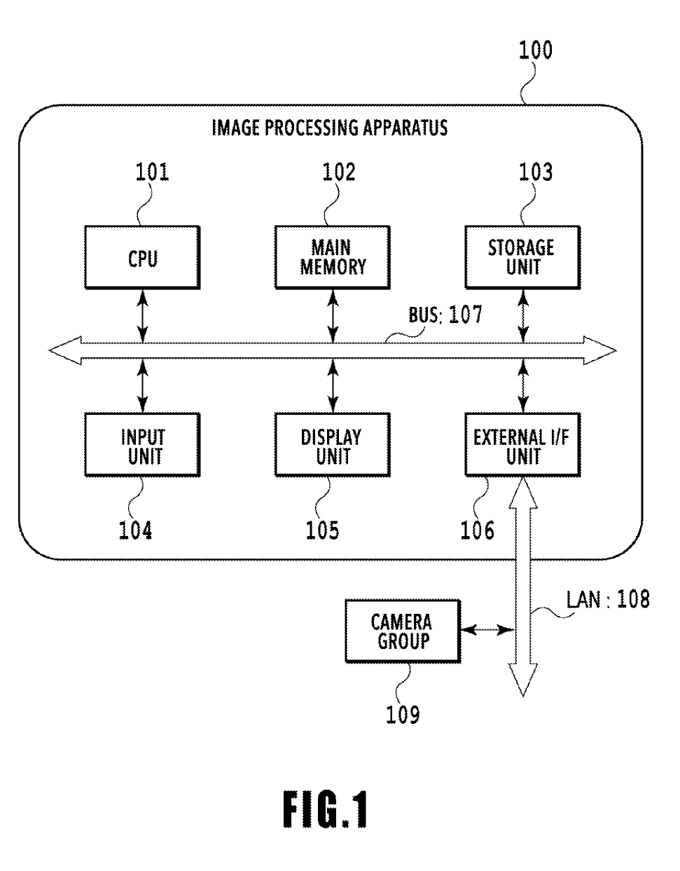

FIG. 1 is a diagram showing an example of a configuration of a virtual viewpoint video image system in the present embodiment. The virtual viewpoint video image system shown in FIG. 1 includes an image processing apparatus 100 and a plurality of image capturing apparatuses (camera group) 109. Then, the image processing apparatus 100 includes a CPU 101, a main memory 102, a storage unit 103, an input unit 104, a display unit 105, and an external I/F 106 and each unit is connected via a bus 107. The image processing apparatus is an apparatus that sets a movement path of a virtual viewpoint relating to a virtual viewpoint image generated based on a plurality of images obtained by a plurality of image capturing apparatuses (camera group). First, the CPU 101 is an arithmetic operation processing device that centralizedly controls the image processing apparatus 100 and performs a variety of pieces of processing by executing various programs stored in the storage device 103 and the like. The main memory 102 provides a work area for the CPU 101 as well as temporarily storing data, parameters, and so on used in various kinds of processing. The storage device 103 is a large-capacity storage device that stores various programs and various kinds of data necessary for a GUI (Graphical User Interface) display and for example, a nonvolatile memory, such as a hard disk and a silicon disk, is used. The input unit 104 is a device, such as a keyboard, a mouse, an electronic pen, and a touch panel, and receives an operation input from a user. The display unit 105 includes a liquid crystal panel and the like and produces a GUI display and the like for virtual camera path setting at the time of virtual viewpoint video image generation. The external I/F unit 106 is connected with each camera configuring the camera group 109 via a LAN 108 and performs transmission and reception of video image data and control signal data. The bus 107 connects each unit described above and performs data transfer.

The camera group 109 is connected with the image processing apparatus 100 via the LAN 108 and starts or stops image capturing, changes camera settings (shutter speed, aperture, and so on), and transfers captured video image data based on a control signal from the image processing apparatus 100.

In the system configuration, a variety of components may exist other than those described above, but explanation thereof is omitted.

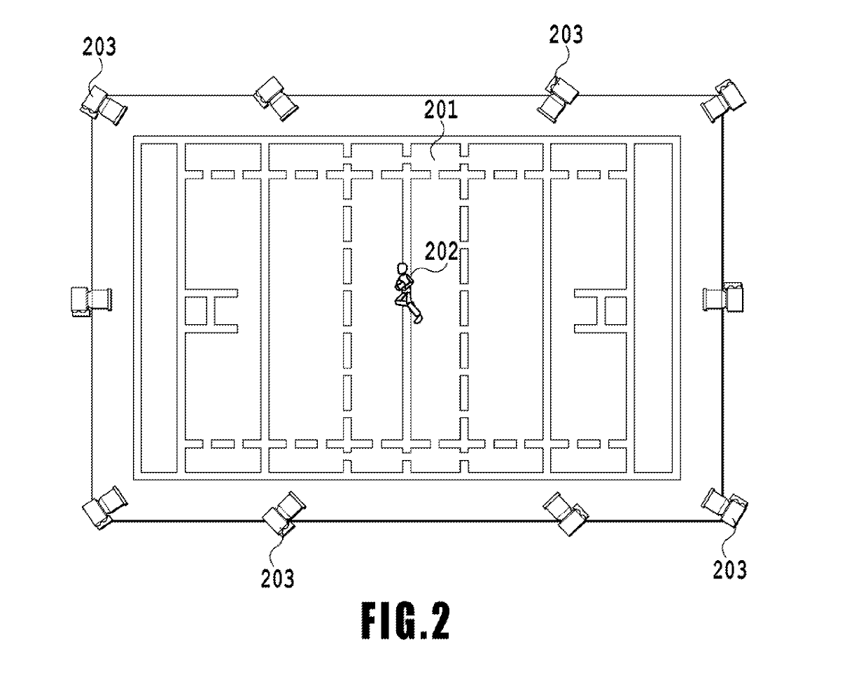

FIG. 2 is a diagram showing an arrangement example of each camera configuring the camera group 109. Here, explanation is given by a case where ten cameras are installed in a sports stadium where rugby is played. However, the number of cameras configuring the camera group 109 is not limited to ten. In a case where the number of cameras is small, the number may be two or three, or there may be a case where hundreds of cameras are installed. On a field 201 where a game is played, a player and a ball, each as an object 202, exist and ten cameras 203 are arranged so as to surround the field 201. For each camera 203 configuring the camera group 109, an appropriate camera orientation, a focal length, an exposure control parameter, and so on are set so that the entire field 201 or an area of interest of the field 201 is included within an angle of view.

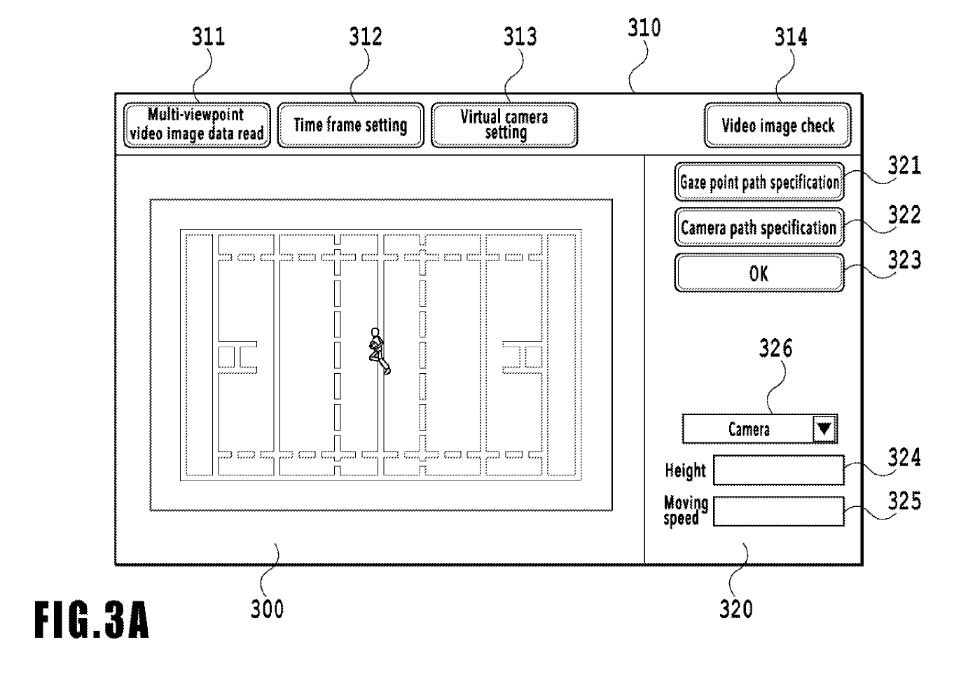

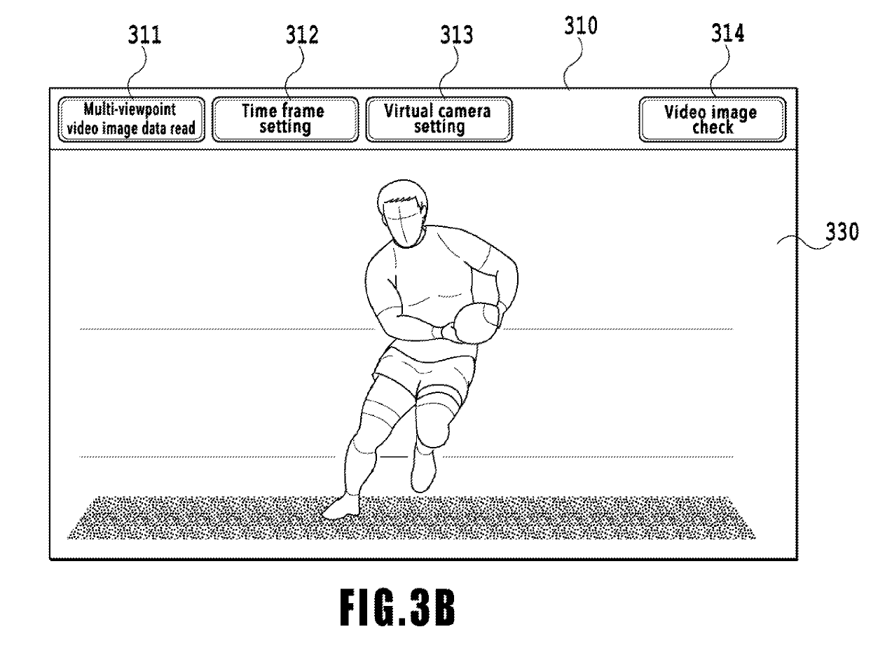

FIG. 3A and FIG. 3B are each a diagram showing an example of a GUI screen used at the time of virtual viewpoint video image generation according to the present embodiment. FIG. 3A is a basic screen of the GUI screen and includes a bird's eye image display area 300, an operation button area 310, and a virtual camera setting area 320.

The bird's eye image display area 300 is made use of for the operation and check to specify a movement path of a virtual camera and a movement path of a gaze point, which is the destination that a virtual camera gazes at. It may also be possible to use the bird's eye image display area 300 for setting only one of the movement path of a virtual camera and the movement path of a gaze point. For example, it may also be possible to cause a user to specify the movement path of a virtual camera by using the bird's eye image display area 300 and for the movement path of a gaze point to be determined automatically in accordance with the movement of a player or the like. Conversely, it may also be possible for the movement path of a virtual camera to be determined automatically in accordance with the movement of a player or the like and to cause a user to specify the movement path of a gaze point by using the bird's eye image display area 300. In the operation button area 310, buttons 311 to 313 for reading multi-viewpoint video image data, setting a range (time frame) of multi-viewpoint video image data, which is a generation target of a virtual viewpoint video image, and setting a virtual camera exist. Further, in the operation button area 310, a check button 314 for checking a generated virtual viewpoint video image exists and by the check button 314 being pressed down, a transition is made into a virtual viewpoint video image preview window 330 shown in FIG. 3B. By this window, it is made possible to check a virtual viewpoint video image, which is a video image viewed from a virtual camera.

The virtual camera setting area 320 is displayed in response to the Virtual camera setting button 313 being pressed down. Then, within the area 320, buttons 321 and 322 for specifying the movement path of a gaze point and the movement path of a virtual camera, and an OK button 323 for giving instructions to start generation of a virtual viewpoint video image in accordance with the specified movement path exist. Further, in the virtual camera setting area 320, display fields 324 and 325 that display the height and the moving speed of a virtual camera (Camera) and a gaze point (Point of Interest) exist and a dropdown list 326 for switching display targets exists. Although not shown schematically, it may also be possible to provide a display field for displaying information (for example, angle information) relating to the image capturing direction of a virtual camera in the virtual camera setting area 320. In this case, it is possible to set an angle in accordance with a user operation for the dropdown list 326.

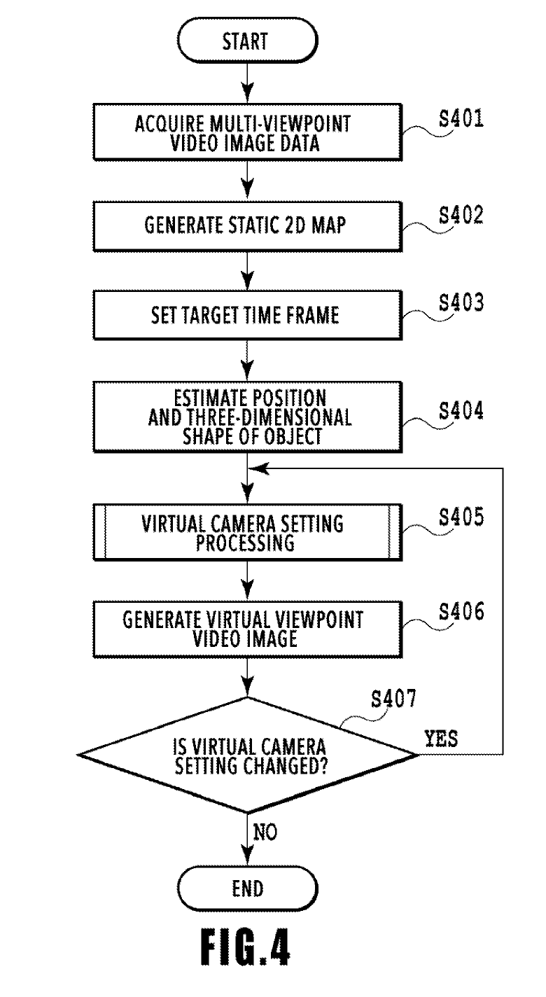

FIG. 4 is a flowchart showing a rough flow of processing to generate a virtual viewpoint video image. The series of processing is implemented by the CPU 101 reading a predetermined program from the storage unit 130, loading the program onto the main memory 102, and executing the program.

At step 401, video image data captured from multiple viewpoints (here, ten viewpoints corresponding to each of the ten cameras) is acquired. Specifically, by a user pressing down the Multi-viewpoint video image data read button 311 described previously, multi-viewpoint video image data captured in advance is read from the storage unit 103. However, the acquisition timing of the video image data is not limited to the timing at which the button 311 is pressed down and various modification examples are considered, for example, such as a modification example in which the video image data is acquired at regular time intervals. Further, in a case where multi-viewpoint video image data captured in advance does not exist, it may also be possible to acquire multi-viewpoint video image data directly by performing image capturing in response to the Multi-viewpoint video image data read button 311 being pressed down. That is, it may also be possible to directly acquire video image data captured by each camera via the LAN 108 by transmitting an image capturing parameter, such as an exposure condition at the time of image capturing, and an image capturing start signal from the image processing apparatus 100 to the camera group 109.

At step 402, a two-dimensional image of a still image (hereinafter, called “static 2D map”) that captures an image capturing scene (here, field of the rugby ground) of the acquired multi-viewpoint video image data from a bird's eye is generated. This static 2D map is generated by using an arbitrary frame in the acquired multi-viewpoint video image data. For example, it is possible to obtain the static 2D map by performing projective transformation for a specific frame of one piece of video image data captured from an arbitrary viewpoint (camera) of the multi-viewpoint video image data. Alternatively, it is possible to obtain the static 2D map by combining images each obtained by performing projective transformation for a specific frame of video image data corresponding to two or more arbitrary viewpoints of the multi-viewpoint video image data. Further, in a case where the image capturing scene is made clear in advance, it may also be possible to acquire the static 2D map by reading a static 2D map created in advance.

At step 403, a time frame, which is a target range of virtual viewpoint video image generation of the acquired multi-viewpoint video image data, is set. Specifically, a user sets a time range (start time and end time) for which a user desires to generate a virtual viewpoint video image by pressing down the Time frame setting button 312 described previously while checking a video image displayed on a separate monitor or the like. For example, in a case where all the acquired video image data corresponds to 120 minutes and ten seconds from the point in time after 63 minutes have elapsed from the start are set, a target time frame is set in such a manner that the start time is 1:03: 00 and the end time is 1:03:10. In a case where the acquired multi-viewpoint video image data is captured at 60 fps and the video image data corresponding to ten seconds is set as the target range as described above, a virtual viewpoint video image is generated based on still image data of 60 (fps)×(10 sec)×10 (cameras)=6,000 frames.

At step 404, in all the frames included in the set target range, the position and the three-dimensional shape (hereinafter, 3D shape) of the object 202 are estimated. As the estimation method, an already-existing method, such as the Visual-hull method that uses contour information on an object and the Multi-view stereo method that uses triangulation, is used. Information on the estimated position and 3D shape of the object is saved in the storage unit 103 as object information. In a case where a plurality of objects exists in the image capturing scene, estimation of the position and the 3D shape is performed for each object.

At step 405, the setting processing of a virtual camera is performed. Specifically, by a user pressing down the Virtual camera setting button 313 described previously, the virtual camera setting area 320 is displayed and a user sets the movement path of a virtual camera and the movement path of a gaze point by operating the button or the like within the area 320. Details of the virtual camera setting processing will be described later.

At step 406, in response to the OK button 323 described previously being pressed down by a user, based on the setting contents relating to a virtual camera set at step 405, a virtual viewpoint video image is generated. It is possible to generate a virtual viewpoint video image by using the computer graphics technique for a video image obtained by viewing the 3D shape of an object from a virtual camera.

At step 407, whether to generate a new virtual viewpoint video image by changing the setting contents of a virtual camera is determined. This processing is performed based on instructions from a user who has checked the image quality and the like by viewing the virtual viewpoint video image displayed in the virtual viewpoint video image preview window 330. In a case where a user desires to generate a virtual viewpoint video image again, the user presses down the Virtual camera setting button 313 again and performs setting relating to a virtual camera anew (the processing returns to step 405). In a case where the setting contents are changed in the virtual camera setting area 320 and the “OK” button is pressed down again, a virtual viewpoint video image is generated with the contents after the change. On the other hand, in a case where there is no problem with the generated virtual viewpoint video image, this processing is exited. The above is the rough flow until a virtual viewpoint video image is generated according to the present embodiment. In the present embodiment, the example is explained in which all the pieces of processing in FIG. 4 are performed by the image processing apparatus 100, but it may also be possible to perform the processing in FIG. 4 by a plurality of apparatuses. For example, it may also be possible to perform the processing relating to FIG. 4 by distributing duties to a plurality of apparatuses so that, for example, step 401 and step 402 are performed by a first apparatus, step 406 is performed by a second apparatus, and the other pieces of processing are performed by a third apparatus. This also applies to the other flowcharts of the present embodiment.

Following the above, the virtual camera setting processing at step 405 described previously is explained in detail. FIG. 5 is a flowchart showing details of the virtual camera setting processing according to the present embodiment. This flow is performed by the Virtual camera setting button 313 described previously being pressed down.

At step 501, the object information and the static 2D map in the set time frame are read from the storage unit 103. The read object information and static 2D map are stored in the main memory 102.

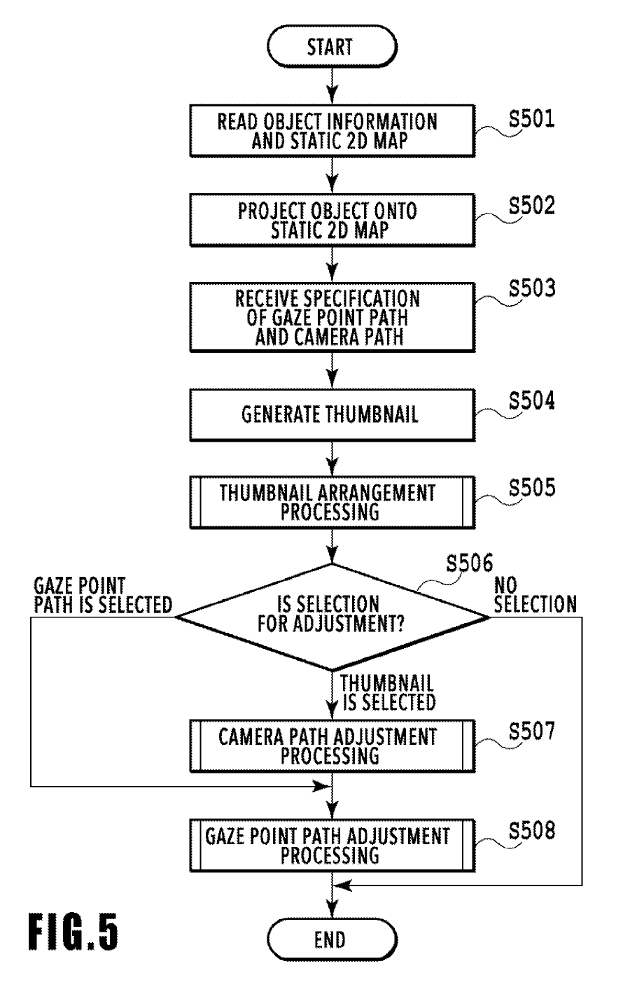

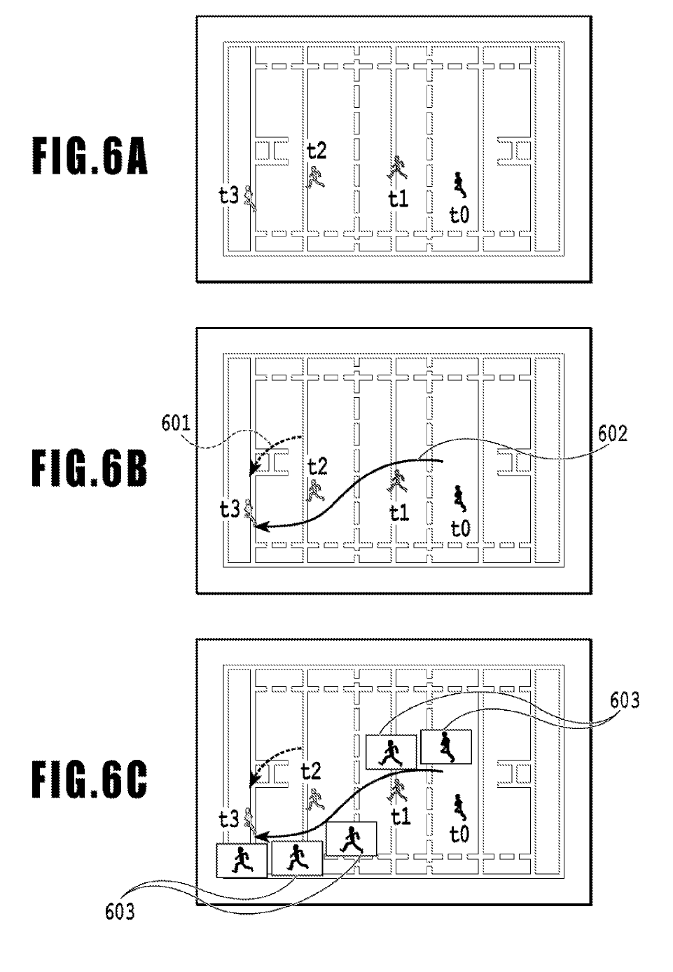

At step 502, based on the read object information and static 2D map, a static 2D map onto which the position and the 3D shape of the object are projected is displayed on the bird's eye image display area 300 on the GUI screen shown in FIG. 3A. FIG. 6A shows results of projecting the object 202 of the player holding the ball onto the static 2D map of the field 201 shown in FIG. 2. The position and the shape of the object 202 make a transition along the time axis, and therefore, all the objects within the time frame set by a user are projected. In this case, on a condition that all the objects corresponding to all the frames are projected, the frames overlap one another as a result of the projection, and therefore, visual recognizability and browsability are reduced. Consequently, all the frames are sampled at regular time intervals (for example, 5 seconds) and only the objects in predetermined frames (in the example in FIG. 6A, t0, t1, t2, t3) are projected. Further, in the example in FIG. 6A, the object is displayed so as to become more transparent with the elapse of time (transparency increases). Due to this, it is possible for a user to grasp the elapse of time at a glance within the set time frame. In the present embodiment, the transparency of the object is made to differ, but any display may be used as long as the elapse of time is known from the display and for example, another aspect in which the luminance is lowered stepwise, or the like may be used. The projection results thus obtained are displayed in the bird's eye image display area 300.

At step 503, information specifying a virtual viewpoint in the virtual viewpoint video image data, that is, a path along which the gaze point moves (hereinafter, gaze point path), which is the direction in which the virtual camera faces, and a path along which the virtual camera moves (hereinafter, camera path) are specified by a user. After pressing down the Gaze point path specification button 321 or the Camera path specification button 322 within the virtual camera setting area 320, a user draws a locus with his/her finger, a mouse, an electronic pen, or the like on the static 2D map within the bird's eye image display area 300. Due to this, a gaze point path and a camera path are specified, respectively. FIG. 6B shows results of specification of a gaze point path and a camera path. In FIG. 6B, a broken line arrow 601 is a gaze point path and a solid line arrow 602 is a camera path. That is, the virtual viewpoint video image that is generated is a virtual video image in a case where while the gaze point of the virtual camera is moving on the curve indicated by the broken line arrow 601, the virtual camera itself moves on the curve indicated by the solid line arrow 602. In this case, the heights of the gaze point and the virtual camera from the field 201 are set to default values, respectively. For example, in a case where the image capturing scene is a rugby game as shown in FIG. 2, the default values are set so that the entire player, who is the object, is included within the angle of view of the virtual camera, that is, for example, the height of the gaze point is 1.5 m and the height of the virtual camera is 10 m. In the present embodiment, it is supposed that a user can freely specify the heights of the virtual camera and the gaze point, respectively, but it may also be possible to set the height of the gaze point to a fixed value and to enable a user to specify only the height of the virtual camera, or to set the height of the virtual camera to a fixed value and to enable a user to specify only the height of the gaze point. Further, in a case where a user is enabled to change the default value arbitrarily, it is made possible for a user to set an appropriate value in accordance with the kind of game or event, and therefore, convenience of a user improves. It may also be possible to fix one of the gaze point and the virtual camera position so that only the other is specified by a user at step 503. Further, it is also possible to adopt a configuration in which, for example, in a case where a user specifies only one of the gaze point path and the camera path, the other is determined automatically. As the moving speed of the gaze point and the virtual camera, a value obtained by dividing the movement distance of the specified movement path by the time frame set at step 402 in the flow in FIG. 4 is set.

At step 504, still images (thumbnail images) in a case where the object is viewed from the virtual camera at regular time intervals in the time axis direction along the set camera path are generated. The “regular time intervals” at this step may be the same as the “regular time intervals” at step 502 described above or may be different time intervals. Further, the thumbnail image is used to predict the resultant virtual viewpoint video image and is referred to in a case where the gaze point path or the camera path is modified or the like, and a resolution at a level at which the purpose can be attained (relatively low resolution) is set. Due to this, the processing load is lightened and high-speed processing is enabled.

At step 505, processing (thumbnail arrangement processing) to arrange the generated thumbnail images along the camera path drawn on the static 2D map onto which the object 202 is projected is performed. That is, at step 505, the image processing apparatus 100 displays a plurality of virtual viewpoint video images in accordance with at least one of the camera path and the gaze point path on a display screen. Details of the thumbnail arrangement processing will be described later. FIG. 6C is a diagram showing an example of the results of the thumbnail arrangement processing and five thumbnail images 603 are arranged along the specified camera path 602. In this manner, in the bird's eye image display area 300, a state where a plurality of thumbnail images is put side by side at regular time intervals along the camera path drawn on the static 2D map is displayed. Then, it is possible for a user to understand instantaneously what kind of virtual viewpoint video image is generated by browsing the thumbnail images along the camera path (=time axis). As a result of this, the number of times of repetition of step 404 to step 406 in the flow in FIG. 4 described previously is reduced significantly.

The subsequent steps 506 to 508 are the processing in a case where the camera path or the gaze point path is adjusted. In a case where a user is not satisfied with a virtual viewpoint video image estimated from the thumbnail images and desires to make adjustment, the user selects one of the plurality of thumbnail images or one position on the gaze point path displayed on the bird's eye image display area 300. In the case of the present embodiment, for example, by a user touching arbitrary one of the thumbnail images 603 or an arbitrary portion of the broken line arrow 601 indicating the gaze point path by his/her finger or the like, this selection is made.

At step 506, whether a user made some selection is determined. That is, at step 506, the image processing apparatus 100 receives a user operation for at least one of the plurality of virtual viewpoint video images displayed on the display screen. In a case where the thumbnail image is selected by a user, the processing advances to step 507 and in a case where an arbitrary portion on the gaze point path is selected, the processing advances to step 508. On the other hand, none of them is selected and the OK button 323 is pressed down, this processing is exited and a transition is made into generation processing of a virtual viewpoint video image (step 405 in the flow in FIG. 4).

At step 507, in accordance with user instructions for the selected thumbnail image, processing (camera path adjustment processing) to adjust the movement path, the height, and the moving speed of the virtual camera is performed. That is, at step 507, the image processing apparatus 100 changes the camera path in accordance with the reception of the operation for the thumbnail image (virtual viewpoint video image). Details of the camera path adjustment processing will be described later.

At step 508, in accordance with the user instructions for a mark (in the present embodiment, x mark) indicating the selected portion on the gaze point path, processing (gaze point path adjustment processing) to adjust the movement path, the height, and the moving speed of the gaze point is performed. Details of the gaze point path adjustment processing will be described later. The above is the contents of the virtual camera setting processing.

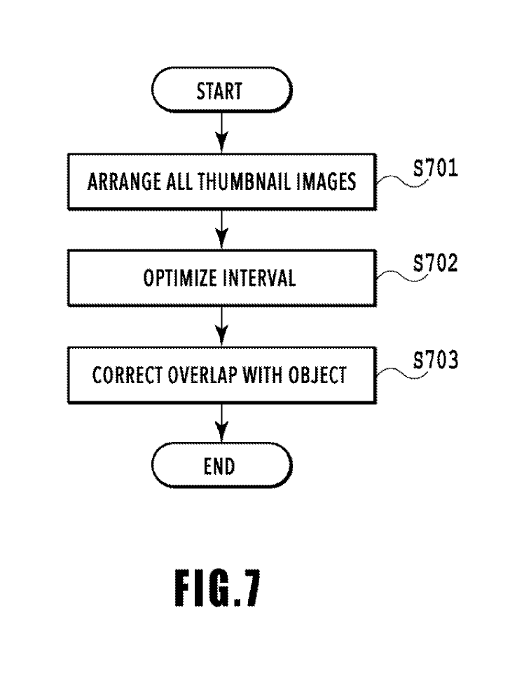

FIG. 7 is a flowchart showing details of the thumbnail arrangement processing (step 505). First, at step 701, the thumbnail images generated by performing sampling at regular time intervals in the time axis direction are arranged along the camera path set at step 503. Then, at step 702, the intervals between the thumbnail images are optimized. Specifically, for the portion at which the thumbnail images cluster together and an overlap occurs as the results of the arrangement at the regular time intervals, processing to thin the thumbnail images is performed so that the overlap is eliminated. Further, for the start point and the endpoint of the camera path, and the inflection point at which a change in the camera path is large, processing to generate and add a thumbnail image anew is performed. Then, at step 703, correction processing to shift the position of the thumbnail image is performed so that each thumbnail image whose interval is optimized and the object that is projected (projected object) do not overlap. Due to this, the visual recognizability of each projected object is secured and it is possible for a user to perform the subsequent editing work smoothly.

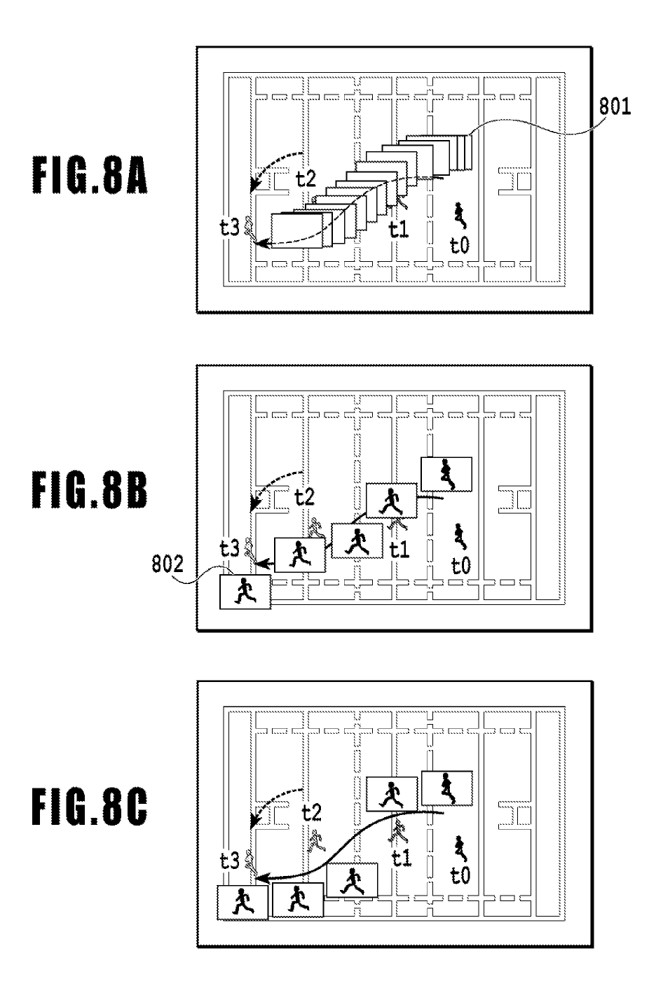

FIG. 8A to FIG. 8C are diagrams explaining the process of the thumbnail arrangement processing. FIG. 8A is the results of step 701 and all generated thumbnail images 801 are arranged at regular time intervals along the camera path, and as a result of this, a state is brought about where almost all the thumbnail images overlap another thumbnail image. FIG. 8B is the results of step 702 and a new thumbnail image 802 is added to the endpoint of the camera path and the overlap of the thumbnail images is resolved. However, a state is brought about where the projected object and the camera path overlap part of the thumbnail images from t1 to t3. FIG. 8C is the results of step 703 and a state is brought about where the thumbnail images that overlap the projected object and the camera path are moved and the visual recognizability of all the projected objects and the thumbnail images is secured. The above is the contents of the thumbnail arrangement processing.

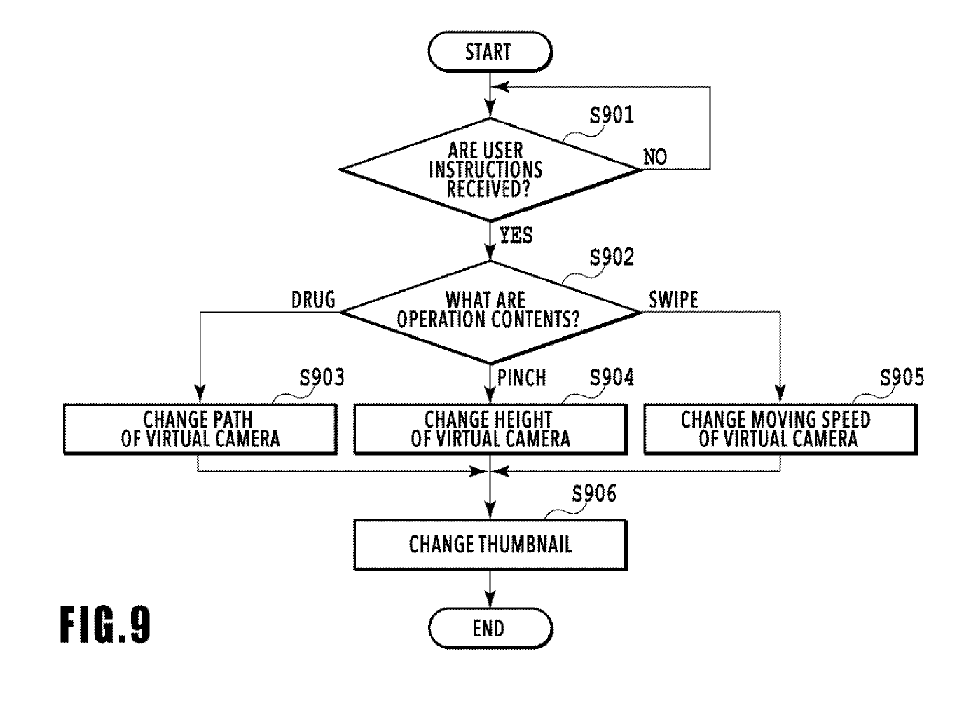

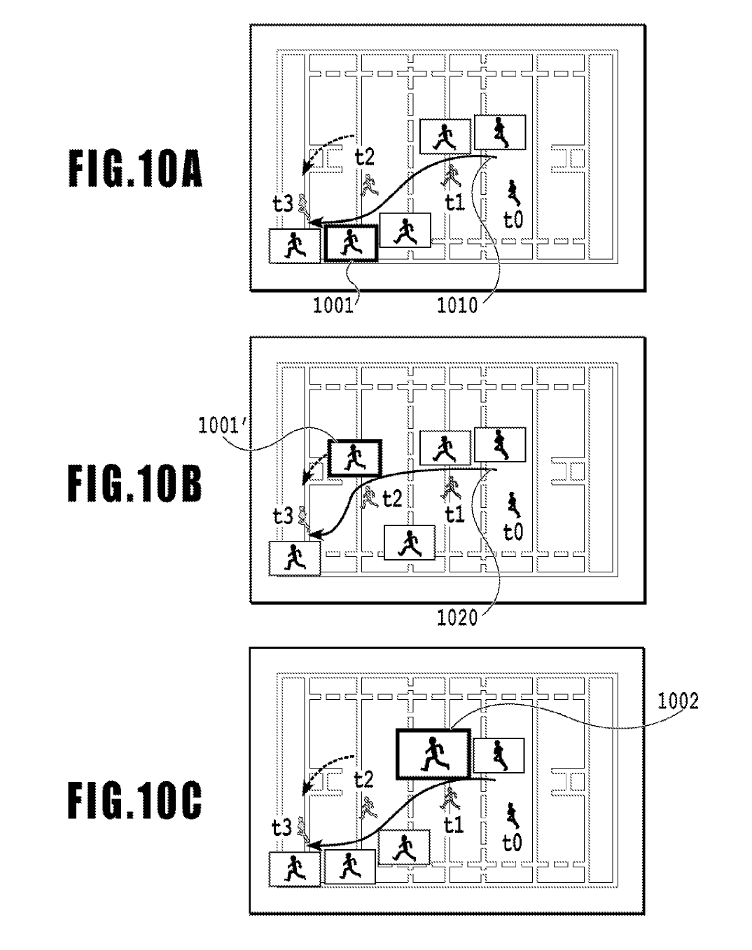

Following the above, the camera path adjustment processing is explained. FIG. 9 is a flowchart showing details of the camera path adjustment processing. As described previously, this processing starts by a user selecting the thumbnail image of the portion at which a user desires to change the position and/or the height of the virtual camera. FIG. 10A to FIG. 10C are diagrams explaining the process of the camera path adjustment processing. As shown in FIG. 10A, a thumbnail image 1001 selected by a user is highlighted by, for example, a thick frame. Further, at this time, by selecting in advance “Camera” in the dropdown list 326, the height and the moving speed of the virtual camera in the frame of interest, which is located at the position corresponding to the thumbnail image in relation to the selection, are displayed in the display fields 324 and 325, respectively. Of course, it may also be possible to display the height and the moving speed of the virtual camera in a table, by a graph, and so on for the entire time frame in which a virtual viewpoint video image is generated, not only the frame of interest. Further, the parameters of the virtual camera, which can be set, are not limited to the height and the moving speed. For example, it may also be possible to display the angle of view and the like of the camera. From this state, the camera path adjustment processing starts.

At step 901, whether user instructions are given to a thumbnail image relating to the user selection (hereinafter, called “selected thumbnail”), which is highlighted, is determined. In the present embodiment, in a case where a touch operation by using the finger of a user him/herself is detected, it is determined that user instructions are given and the processing advances to step 902.

At step 902, the processing is branched in accordance with the contents of the user instructions. In a case where the user instructions are a drug operation by one finger for the selected thumbnail, the processing advances to step 903, in a case of a pinch operation by two fingers, the processing advances to step 904, and in a case of a swipe operation by two fingers, the processing advances to step 905, respectively.

At step 903, in accordance with the movement of the selected thumbnail by the one-finger drug operation, the movement path of the virtual camera is changed. FIG. 10B is a diagram showing the way the movement path of the virtual camera is changed in accordance with a result of the selected thumbnail 1001 being moved to a position 1001′ by the drug operation. It is known that the camera path indicating the locus such as a solid line arrow 1010 in FIG. 10A is changed to the camera path of a different locus such as a solid line arrow 1020 in FIG. 10B. The camera path between the thumbnail image being selected and the adjacent thumbnail image is interpolated by a spline curve or the like.

At step 904, the height of the virtual camera is changed in accordance with a change in the size of the selected thumbnail by the two-finger pinch operation (the interval is increased or narrowed by two fingers). In FIG. 10C, a selected thumbnail 1002 whose size is increased by the pinch operation is shown. By the pinch operation, the size of the selected thumbnail increases or decreases, and therefore, as the size increases, the height is decreased and as the size decreases, the height is increased. Of course the relationship between the magnitude of the size of the thumbnail image and the height of the virtual camera may be opposite and for example, it may also be possible to increase the height as the size increases. That is, what is required is that the size of the selected thumbnail and the height of the virtual camera at the position be interlocked with each other. At this time, by selecting in advance “Camera” in the dropdown list 326, a numerical value indicating the height of the virtual camera in accordance with a change in size is displayed in the display field 324. The camera path between the thumbnail image being selected and the adjacent thumbnail image is modified by spline interpolation or the like.

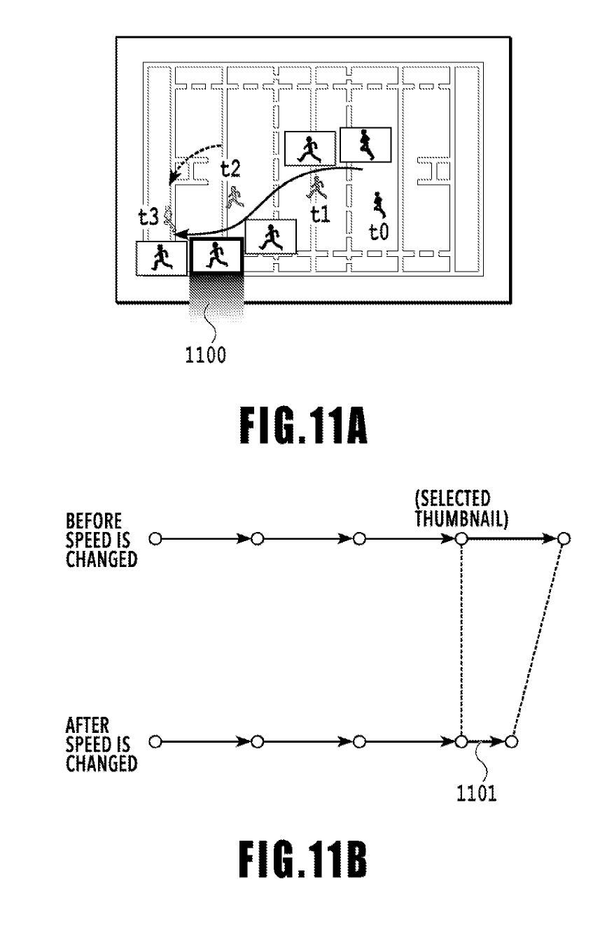

At step 905, the moving speed of the virtual camera is changed in accordance with addition of a predetermined icon to the selected thumbnail by the two-finger swipe operation. FIG. 11A is a diagram showing a state where a gradation icon 1100 whose density changes stepwise is added by the two-finger swipe operation for the fourth selected thumbnail from the start time. At this time, the shape of the gradation icon 1100 and the moving speed are correlated with each other. For example, the greater the length of the gradation icon 1100, the higher the moving speed is, the shorter the length of the gradation icon, the lower the moving speed is, and so on. As described above, the shape of the icon to be added to the selected thumbnail is caused to indicate the moving speed of the virtual camera at the position. Further, by selecting in advance “Camera” in the dropdown list 326, a numerical value indicating the moving speed of the virtual camera in accordance with a change in the shape of the added icon is displayed in the display field 325. FIG. 11B is a diagram explaining a relationship between each thumbnail image, the moving speed of the virtual camera, and the reproduction time of the virtual viewpoint video image and the upper portion indicates the state before the moving speed is changed and the lower portion indicates the state after the moving speed is changed. Then, circle marks indicate the five thumbnail images in FIG. 11A and each thumbnail image at the upper portion corresponds to each time obtained by equally dividing the reproduction time of the set time frame. Here, the example is shown in which the fourth thumbnail image from the start time is selected and the moving speed is adjusted. Here, it is assumed that the moving speed of the virtual camera is increased by performing the swipe operation for the selected thumbnail. In this case, as shown by a thick line arrow 1101 at the lower portion in FIG. 11B, the reproduction time between the fourth thumbnail image being selected and the thumbnail image to the left, which is the future thumbnail image, is reduced. As a result of this, the motion of the object in the frames corresponding to between both the thumbnail images becomes fast in accordance with the reproduction time. Further, the reproduction time of all the virtual viewpoint video images to be completed finally is reduced accordingly. On the contrary, in a case where the moving speed of the selected thumbnail is reduced, the reproduction time lengthens accordingly. At this time, the moving speed of the virtual camera and the moving speed of the gaze point corresponding to between both the thumbnail images are different, and therefore, it may also be possible to cause the reproduction times of all the virtual viewpoint video images to coincide with each other by automatically modifying the moving speed of the corresponding gaze point. Alternatively, it may also be possible to modify one of the moving speed of the virtual camera and the moving speed of the gaze point after changing the moving speed of the gaze point at step 1205, to be described later.

At step 906, each thumbnail image is updated with the contents after the change as described above. The above is the contents of the camera path adjustment processing. In the present embodiment, the processing is branched in accordance with the kind of touch operation using a finger(s) of a user him/herself indicated by user instructions, but in a case of an electronic pen or a mouse, it may also be possible to branch the processing in accordance with whether, for example, the operation is an operation while pressing the “Ctrl” key or the “Shift” key.

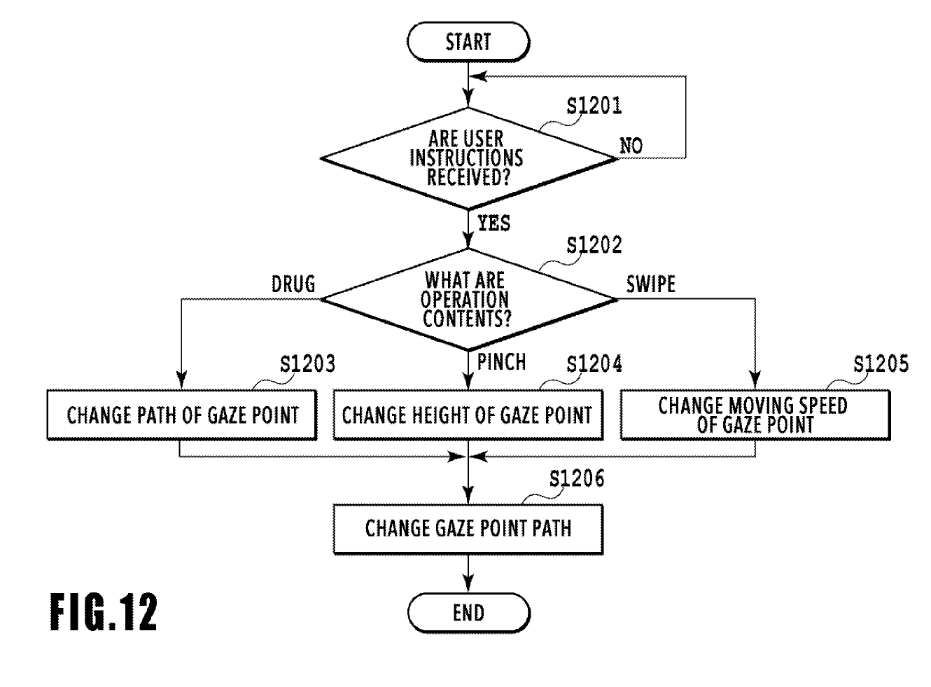

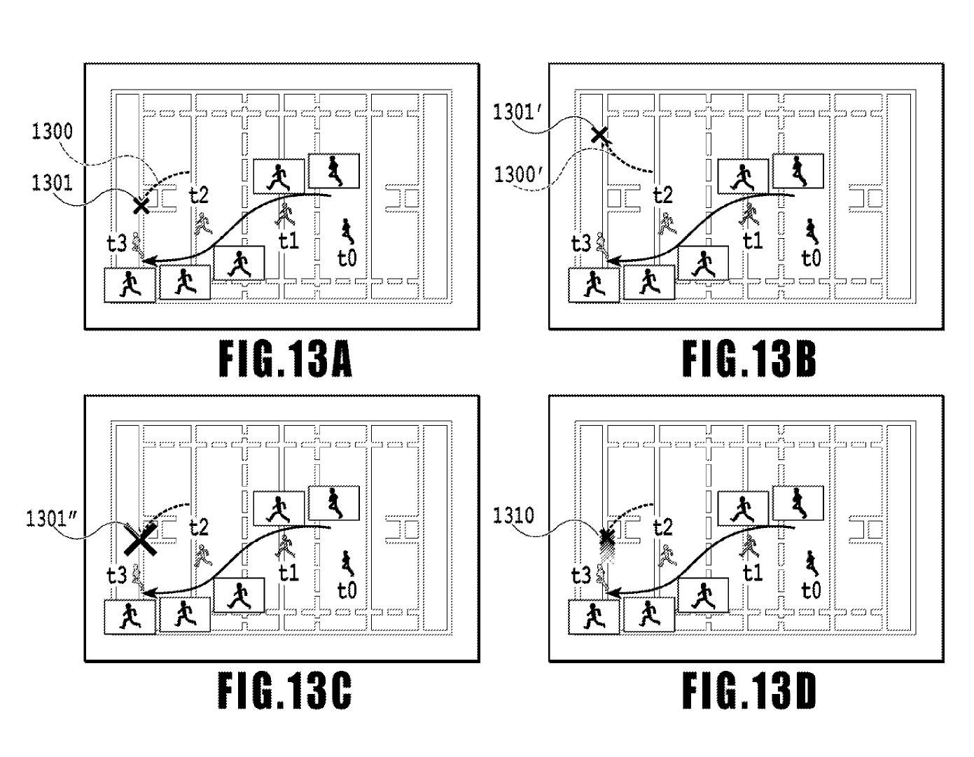

Next, the gaze point path adjustment processing is explained. FIG. 12 is a flowchart showing details of the gaze point path adjustment processing. As described previously, this processing starts by a user selecting an arbitrary portion on the gaze point path at which a user desires to change the position and/or the height. FIG. 13A to FIG. 13D are diagrams explaining the process of the gaze point path adjustment processing. As shown in FIG. 13A, an arbitrary portion (selected portion) on the gaze point path relating to the user election is highlighted by, for example, a thick line x mark 1301. Further, at this time, by selecting in advance “Point of Interest” in the dropdown list 326, the height and the moving speed of the gaze point at the position corresponding to the selected portion are displayed in the display fields 324 and 325, respectively. From this state, the gaze point path adjustment processing starts.

At step 1201, whether user instructions are given to the x mark 1301 indicating the selected portion on the gaze point path is determined. In the present embodiment, in a case where a touch operation using a finger(s) of a user him/herself is detected, it is determined that user instructions are given and the processing advances to step 1202.

At step 1202, the processing is branched in accordance with the contents of user instructions. In a case where the user instructions are the one-finger drug operation for the x mark 1301 indicating the selected portion, the processing advances to step 1203, in a case of the two-finger pinch operation, the processing advances to step 1204, and in a case of the two-finger swipe operation, the processing advances to step 1205, respectively.

At step 1203, in accordance with the movement of the x mark 1301 by the one-finger drug operation, the movement path of the gaze point is changed. FIG. 13B is a diagram showing the way the movement path of the gaze point is changed in accordance with a result of the x mark 1301 being moved to a position 1301′ by the drug operation. It is known that the gaze point path indicating the locus such as a broken line arrow 1300 in FIG. 13A is changed into a gaze point path of a different locus such as a broken line arrow 1300′ in FIG. 13B. The gaze point path between the thumbnail image being selected and the adjacent thumbnail image is interpolated by a spline curve or the like.

At step 1204, the height of the gaze point is changed in accordance with a change in the size of the x mark 1301 by the two-finger pinch operation. In FIG. 13C, a x mark 1301″ whose size is increased by the pinch operation is shown. By the pinch operation, the size of the selected thumbnail increases or decreases, and therefore, for example, as the size increases, the height is decreased and as the size decreases, the height is increased. Of course the relationship between the magnitude of the size of the x mark and the height of the gaze point may be opposite and for example, it may also be possible to increase the height as the size increases. That is, what is required is that the size of the x mark indicating the selected portion and the height of the gaze point at the position be interlocked with each other. At this time, by selecting in advance “Point of Interest” in the dropdown list 326, a numerical value indicating the height of the gaze point in accordance with a change in size is displayed in the display field 324. At this time, in order to prevent a change in height from becoming steep, the height of the gaze point path within a predetermined range sandwiching the selected portion is also modified by spline interpolation or the like.

At step 1205, the moving speed of the gaze point is changed in accordance with addition of a predetermined icon to the x mark 1301 by the two-finger swipe operation. FIG. 13D is a diagram showing a state where a gradation icon 1310 whose density changes stepwise is added by the two-finger swipe operation for the x mark 1301. At this time, the shape of the gradation icon 1310 and the moving speed are correlated with each other. For example, the greater the length of the gradation icon 1310, the higher the moving speed is, the shorter the length of the gradation icon 1310, the slower the moving speed is, and so on. As described above, the shape of the icon to be added to the mark (here, x mark) indicating the selected portion is caused to indicate the moving speed of the gaze point at the position. Further, by selecting in advance “Point of Interest” in the dropdown list 326, a numerical value indicating the moving speed of the gaze point in accordance with a change in the shape of the added icon is displayed in the display field 325.

At step 1206, the gaze point path is updated with the contents after the change as described above. The above is the contents of the gaze point path adjustment processing.

As above, according to the present embodiment, it is made possible to set a virtual camera path simply and in a brief time, which is visually easy to understand. Further, it is also made possible to set the height and the moving speed of a virtual camera on a two-dimensional image, which was difficult in the past. That is, according to the present embodiment, it is also possible to arbitrarily set the height and the moving speed of a virtual camera and to obtain a virtual viewpoint video image in a brief time by a simple operation.

### Second Embodiment

The GUI screen of the first embodiment has the aspect in which the movement path or the like of a virtual camera is specified on a two-dimensional image by a still image. Next, an aspect is explained as a second embodiment in which the movement path or the like of a virtual camera is specified on a two-dimensional image by a moving image. Explanation of the portions in common to those of the first embodiment, such as the basic configuration of the image processing apparatus 100, is omitted and in the following, setting processing of a virtual camera using a two-dimensional image of a moving image, which is a different point, is explained mainly.

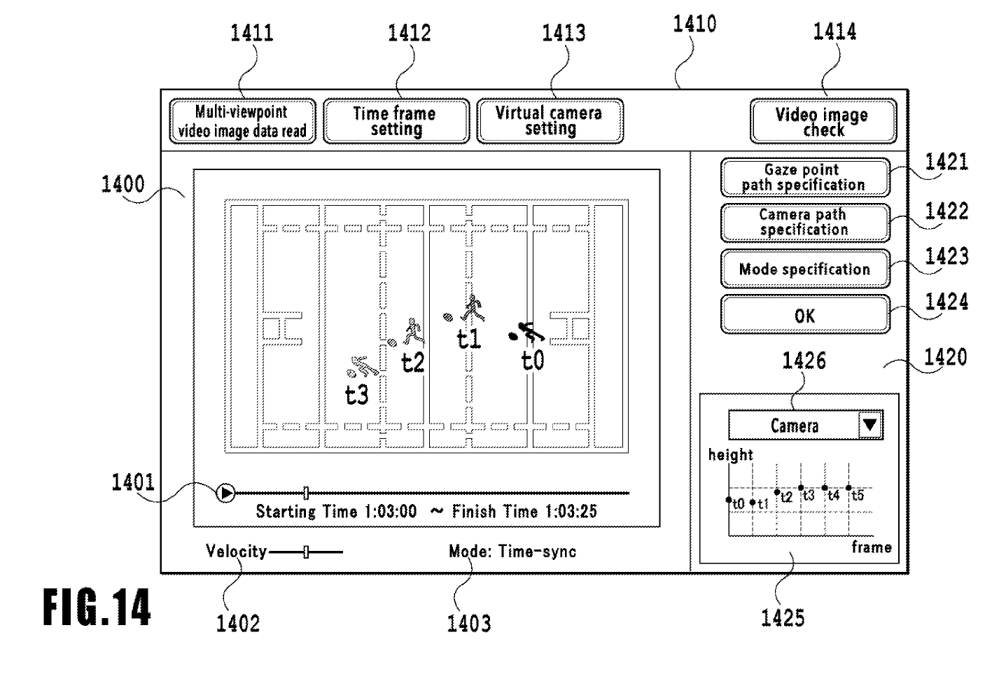

FIG. 14 is a diagram showing an example of a GUI screen used at the time of virtual viewpoint video image generation according to the present embodiment. FIG. 14 is a basic screen of a GUI screen according to the present embodiment, including a bird's eye image display area 1400, an operation button area 1410, and a virtual camera setting area 1420. In the present embodiment, explanation is given on the assumption that the input operation, such as specification of a gaze point path or a camera path, is performed with an electronic pen.

The bird's eye image display area 1400 is made use of for the operation and check to specify a movement path of a virtual camera and a movement path of a gaze point, and a two-dimensional image of a moving image (hereinafter, called “dynamic 2D map”) that grasps an image capturing scene from a bird's eye is displayed. Then, within the bird's eye image display area 1400, a progress bar 1401 that displays the reproduction, stop, and progress situation of the dynamic 2D map corresponding to a target time frame and an adjustment bar 1402 for adjusting the reproduction speed of the dynamic 2D map exist. Further, a Mode display field 1403 that displays a mode at the time of specifying the movement path of a virtual camera, the movement path of a gaze point, and son on also exists. Here, the mode includes two kinds, that is, “Time-sync” and “Pen-sync”. “Time-sync” is a mode in which the movement path of a virtual camera or a gaze point is input as the reduction of the dynamic 2D map advances. “Pen-sync” mode is a mode in which the reproduction of the dynamic 2D map advances in proportion to the length of the movement path input with an electronic pen or the like.

In the operation button area 1410, buttons 1411 to 1413 each for reading multi-viewpoint video image data, setting a target time frame of virtual viewpoint video image generation, and setting a virtual camera exist. Further, in the operation button area 1410, a check button 1414 for checking a generated virtual viewpoint video image exists and by this button being pressed down, a transition is made into a virtual viewpoint video image preview window (see FIG. 3B of the first embodiment). Due to this, it is made possible to check a virtual viewpoint video image, which is a video image viewed from a virtual camera.

The virtual camera setting area 1420 is displayed in response to the virtual camera setting button 1413 being pressed down. Then, within the virtual camera setting area 1420, a button 1421 for specifying the movement path of a gaze point, a button 1422 for specifying the movement path of a virtual camera, a button 1423 for specifying a mode at the time of specifying the movement path, and on OK button 1424 for giving instructions to start generation of a virtual viewpoint video image in accordance with the specified movement path exist. Further, in the virtual camera setting area 1420, a graph 1425 displaying the height and moving speed of a virtual camera (Camera) and a gaze point (Point of Interest) and a dropdown list 1426 for switching display targets exist. In the graph 1425, the vertical axis represents the height and the horizontal axis represents the number of frames and each point indicates each point in time (here, t0 to t5) in a case where the set time frame is divided by a predetermined number. In this case, t0 corresponds to the start frame and t5 corresponds to the last frame. It is assumed that a target time frame corresponding to 25 seconds is set, such as that the start time is 1:03:00 and the end time is 1:03:25. In a case where the number of frames per second of the multi-viewpoint video image data is 60 fps, 60 (fps)×25 (sec)=1,500 frames are the total number of frames in the dynamic 2D map at this time. It is possible for a user to change the height of the virtual camera or the gaze point at an arbitrary point in time in the target time frame by selecting each point on the graph 1425 with an electronic pen and moving the point in the vertical direction.

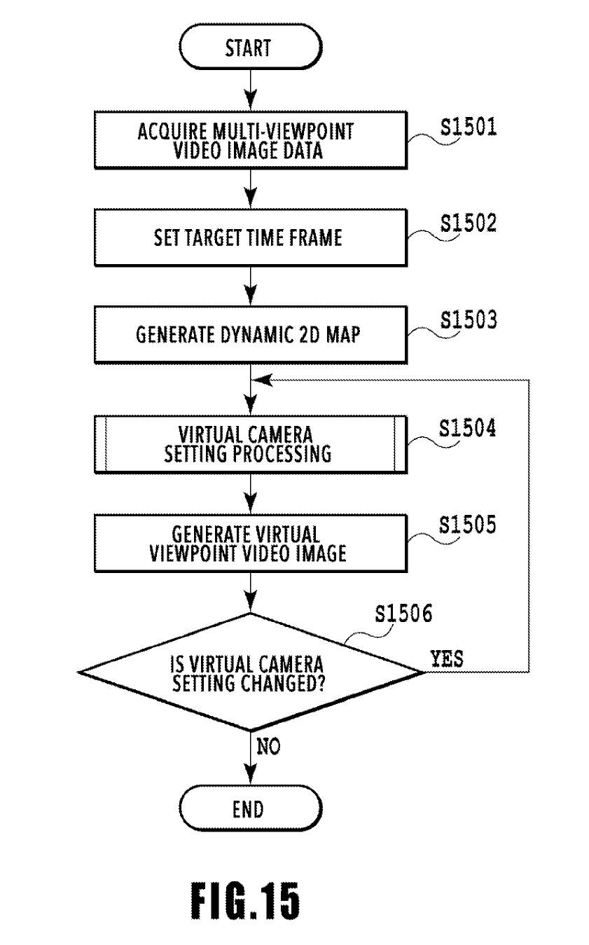

FIG. 15 is a flowchart showing a rough flow of processing to generate a virtual viewpoint video image according to the present embodiment. In the following, explanation is given mainly to differences from the flow in FIG. 4 of the first embodiment.

In a case where multi-viewpoint video image data is acquired at step 1501, at step 1502 that follows, of the acquired multi-viewpoint video image data, a target time frame (start time and end time) of virtual viewpoint video image generation is set. The dynamic 2D map is a two-dimensional moving image in a case where an image capturing scene corresponding to the target time frame is viewed from a bird's eye, and therefore, the dynamic 2D map is generated after the target time frame is set.

At step 1503, the dynamic 2D map corresponding to the set time frame is generated and saved in the storage unit 13. As a specific dynamic 2D map creation method, projective transformation is performed for a video image in the set time frame of the video image data corresponding to one arbitrary viewpoint of the multi-viewpoint video image data. Alternatively, it is also possible to obtain the dynamic 2D map by performing projective transformation for each video image in the set time frame of the video image data corresponding to two or more arbitrary viewpoints of the multi-viewpoint video image data and by combining a plurality of acquired pieces of video image data. In this case, in the latter, crush or the like of the object shape is suppressed and a high image quality is obtained, but the processing load increases accordingly. In the former, although the image quality is low, the processing load is light, and therefore, high-speed processing is enabled.

Step 1504 to step 1506 correspond to step 405 to step 407, respectively, in the flow in FIG. 4 of the first embodiment. However, as will be described later, regarding the contents of the virtual camera setting processing at step 1504, there are many different points as described below because the 2D map that is used is a moving image, not a still image.

The above is the rough flow until a virtual viewpoint video image is generated in the present embodiment.

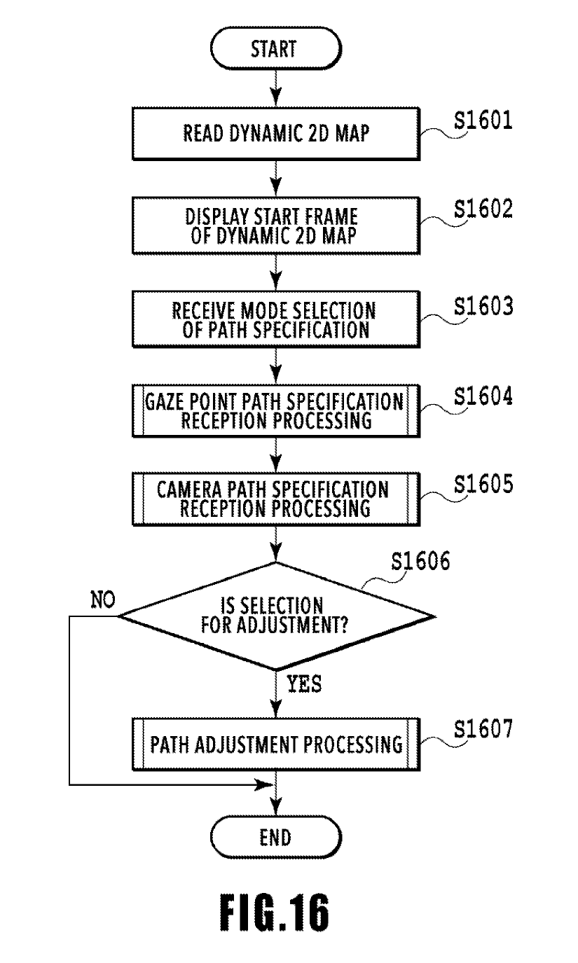

Following the above, the virtual camera setting processing using the above-described dynamic 2D map is explained. FIG. 16 is a flowchart showing details of the virtual camera setting processing according to the present embodiment. This flow is performed by the Virtual camera setting button 1413 described previously being pressed down.

At step 1601, the dynamic 2D map of the set time frame is read from the storage unit 103. The read dynamic 2D map is stored in the main memory 102.

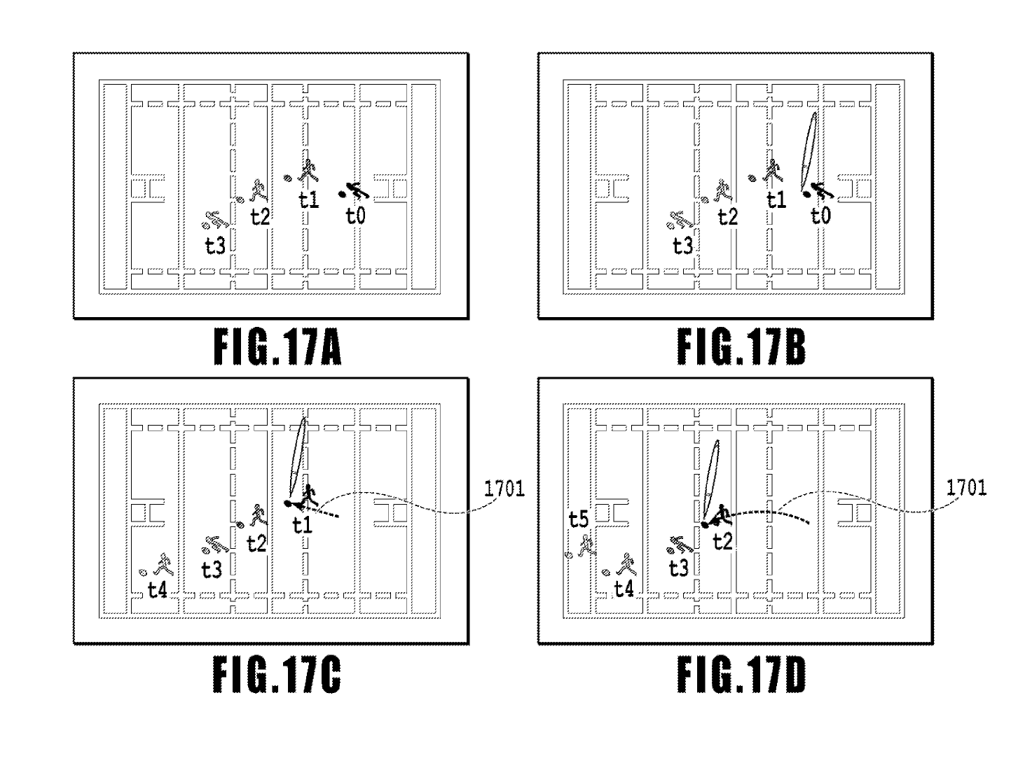

At step 1602, the start frame (frame at the point in time t0) of the read dynamic 2D map is displayed on the bird's eye image display area 1400 on the GUI screen shown in FIG. 14. FIG. 17A is an example of the start frame of the dynamic 2D map. In the present embodiment, of the portions (t0 to t5) obtained by performing sampling for the time frame set by a user at regular time intervals (for example, five seconds), the frames from the point in time being reproduced currently to a predetermined point in time are displayed in an overlapping manner. In the example in FIG. 17A, the frames from the start frame at t0 to the frame at t3, corresponding to 15 seconds, are displayed in an overlapping manner. At this time, the object in the frame farther from the current point in time is displayed in a more transparent manner (transparency increases) and this is the same as in the first embodiment. Due to this, it is possible for a user to grasp the elapse of time within the set time frame at a glance, and by further limiting the display range in terms of time, browsability improves.

At step 1603, user selection of a mode at the time of specifying a gaze point path or a camera path is received and one of “Time-sync” and “Pen-sync” is set. The set contents are displayed in the Mode display field 1403 within the bird's eye image display area 1400. In a case where there is no user selection, it may also be possible to advance to the next processing with the contents of the default setting (for example, “Time-sync”).

At step 1604, processing to receive specification of a gaze point path (gaze point path specification reception processing) is performed. After pressing down the Gaze point path specification button 1421 within the virtual camera setting area 1420, a user draws a locus on the dynamic 2D map within the bird's eye image display area 1400 by using an electronic pen. Due to this, a gaze point path is specified. FIG. 17B to FIG. 17D are diagrams showing in a time series the way a gaze point path is specified on the dynamic 2D map shown in FIG. 17A and a broken line arrow 1701 is the specified gaze point path. FIG. 17B shows the state of the dynamic 2D map in a case where the current point in time is t0, FIG. 17C shows that in a case where the current point in time is t1, and FIG. 17D shows that in a case where the current point in time is t2, respectively. For example, in FIG. 17C, because the current point in time is t1, the object (frame) at the point in time t0 in the past is no longer displayed and instead, the object (frame) at the point in time t4 is displayed. By limiting the range of the object to be displayed in terms of time as described above, it is possible to improve browsability. It may also be possible to display all frames in the set time frame without limiting the range in terms of time under a predetermined condition, such as a case where the set time frame is a short time. In this case, it may also be possible to enable a user to grasp the elapse of time by performing processing to display the object in a transparent manner or the like also for the past frame. The gaze point path specification reception processing differs in contents depending on the mode specified at step 1603. Details of the gaze point path specification reception processing in accordance with the mode will be described later.

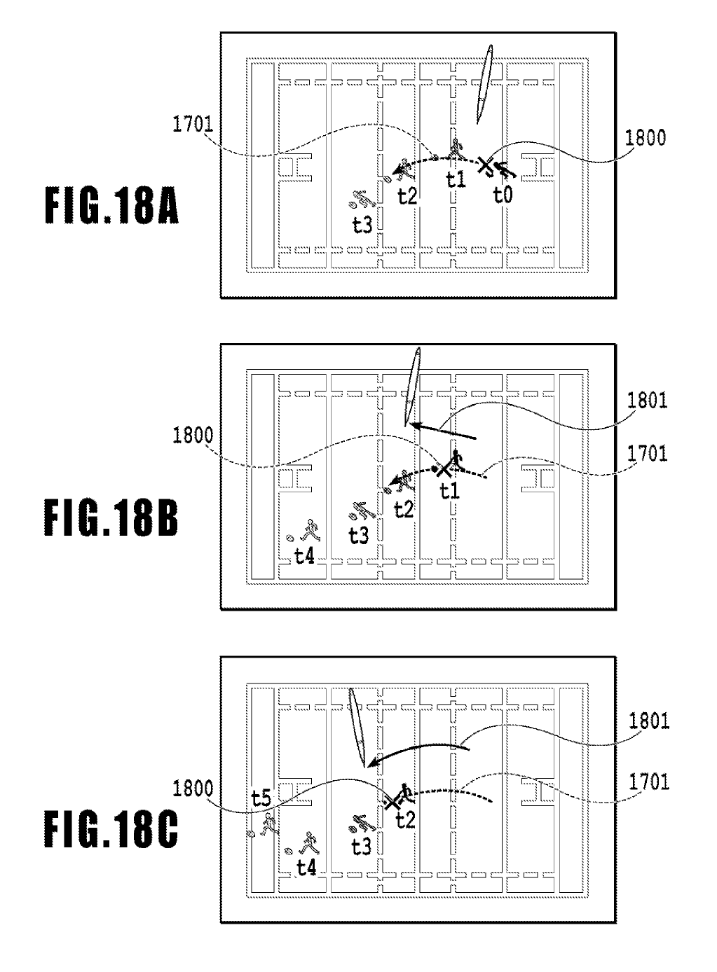

At step 1605, processing to receive specification of a camera path (camera path specification reception processing) is performed. As in the case with the gaze point path described above, after pressing down the Camera path specification button 1422 within the virtual camera setting area 1420, a user draws a locus on the dynamic 2D map within the bird's eye image display area 1400 by using an electronic pen. Due to this, a camera path is specified. FIG. 18A to FIG. 18C are diagrams showing in a time series the way a camera path is specified on the dynamic 2D map after the specification of a gaze point path is completed (see FIG. 17D). In FIG. 18A to FIG. 18C, a x mark 1800 indicates the current position of the gaze point on the specified gaze point path 1701 and a solid line arrow 1801 indicates the specified camera path. FIG. 18A shows the state of the dynamic 2D map in a case where the current point in time is t0, FIG. 18B shows that in a case where the current point in time is t1, and FIG. 18C shows that in a case where the current point in time is t2, respectively. For example, in FIG. 18B, because the current point in time is t1, the object (frame) at the point in time t0 is no longer displayed and instead, the object (frame) at the point in time t4 is displayed. The contents of the camera path specification reception processing also differ depending on the mode specified at step 1603. Details of the camera path specification reception processing in accordance with the mode will be described later.

At step 1606, whether a user makes some selection for adjustment is determined. In a case where a gaze point or a camera path on the dynamic 2D map, or a point on the graph 1425 is selected by a user, the processing advances to step 1607. On the other hand, in a case where the OK button 1424 is pressed down without any selection being made, this processing is exited and a transition is made into the generation processing of a virtual viewpoint video image (step 1505 in the flow in FIG. 15).

At step 1607, in accordance with the input operation for the selected gaze point path or camera path, processing to adjust the movement path, the height, and the moving speed of the virtual camera (path adjustment processing) is performed. Details of the path adjustment processing will be described later.

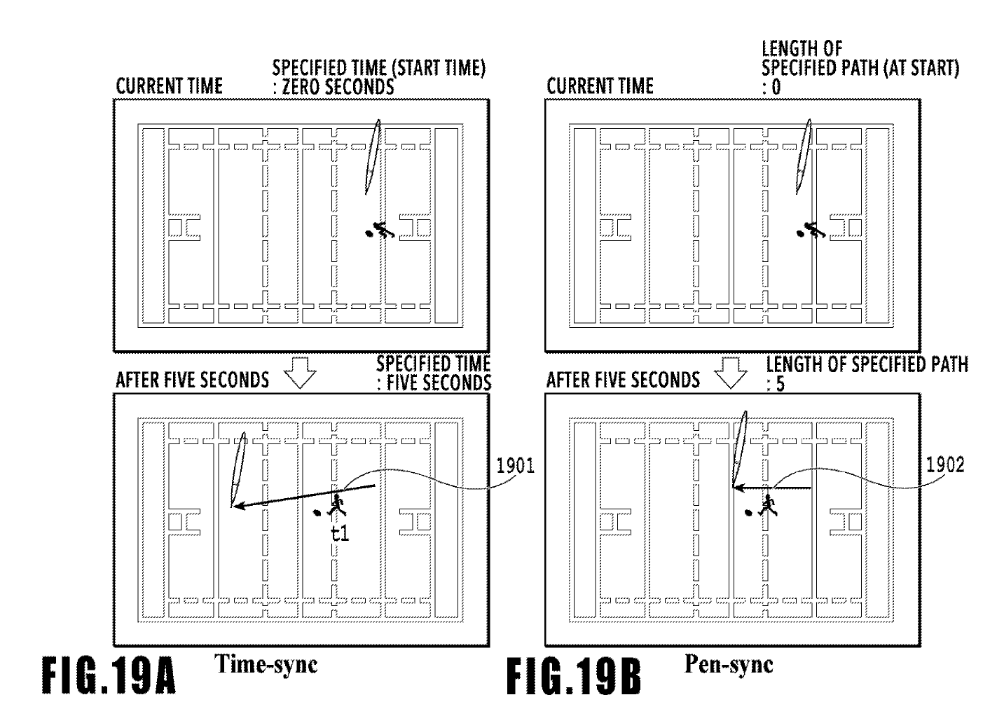

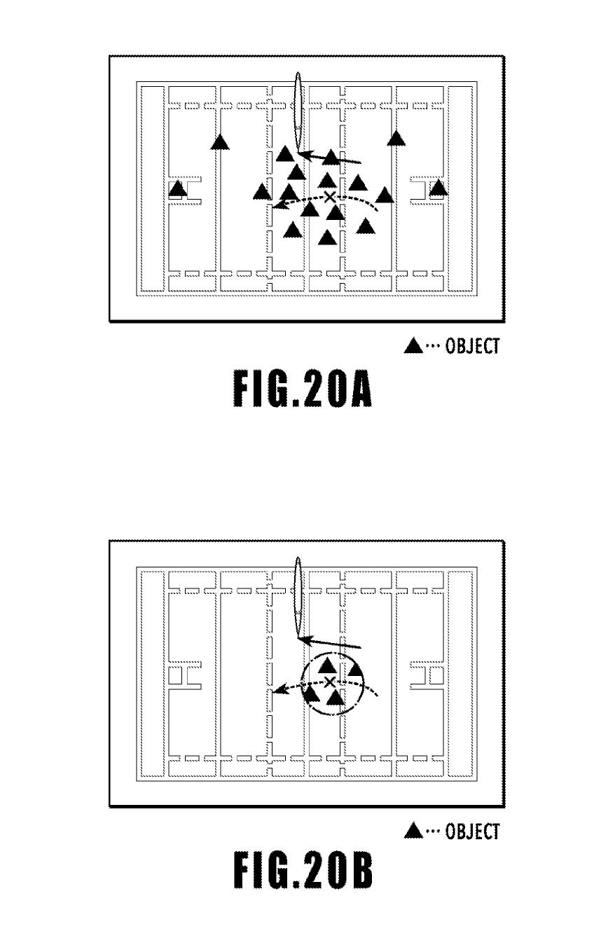

Following the above, the gaze point path specification reception processing (step 1604) and the camera path specification reception processing (step 1605) are explained. Before explanation of the details of each piece of processing is given, the difference depending on the mode at the time of specifying a camera path is explained with reference to FIG. 19A and FIG. 19B. FIG. 19A shows a case of the “Time-sync” mode and FIG. 19B shows a case of the “Pen-sync” mode, respectively. In FIG. 19A and FIG. 19B, solid line arrows 1901 and 1902 show specified movement paths, respectively. In “Time-sync” shown in FIG. 19A, the locus drawn by a user operating an electronic pen while the dynamic 2D map advances five seconds is the path 1901. In contrast to this, in “Pen-sync” shown in FIG. 19B, it is meant that the length of the locus (=path 1902) drawn by a user operating an electronic pen corresponds to five seconds. In FIG. 19A and FIG. 19B, for convenience of explanation, the object of the different time axis is omitted, but as described previously, on the actual GUI screen, the object of the different time axis is also displayed, for example, with a changed transparency. Further, at the time of receiving specification of a camera path, for example, it may also be possible to spatially narrow the objects to be displayed by displaying the inside of a predetermined range with the gaze point at the current position as a center (only the periphery of the gaze point) as shown in FIG. 20A and FIG. 20B. FIG. 20A is an example of a bird's-eye view (one frame in the dynamic 2D map) before spatial narrowing is performed and FIG. 20B is an example of a bird's-eye view after spatial narrowing is performed. As described above, it is possible to improve browsability by bringing the objects located at positions distant from the gaze point into an invisible state.

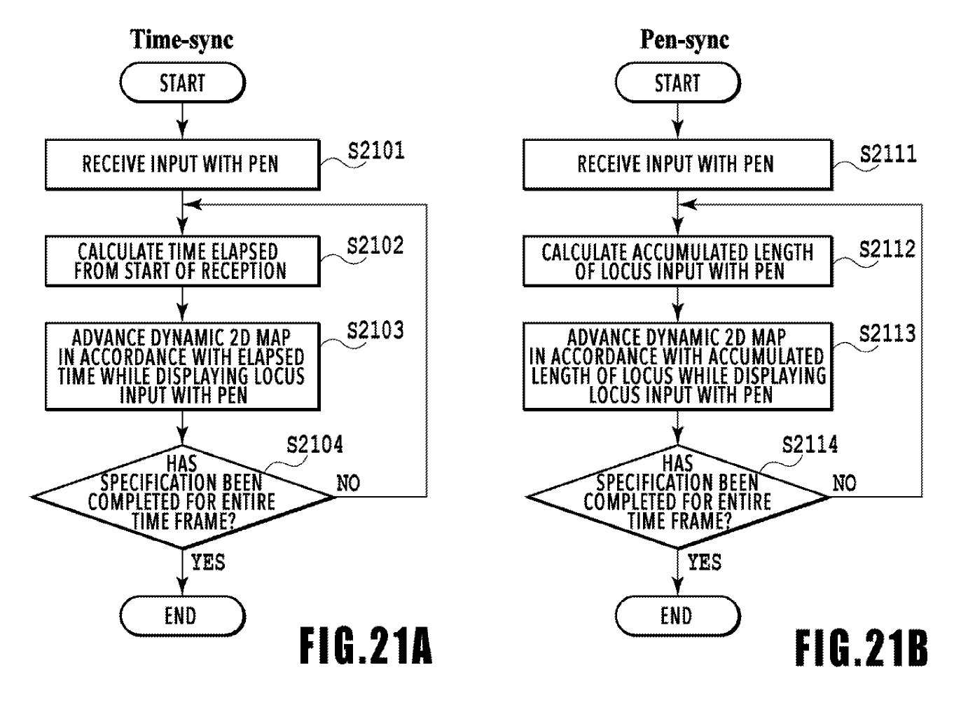

FIG. 21A is a flowchart showing details of the gaze point path specification reception processing in the case of “Time-sync” and FIG. 21B is that in the case of “Pen-sync”. As described previously, this processing starts by a user pressing down the Gaze point path specification button 1421.

First, the case of “Time-sync” is explained along the flow in FIG. 21A. At step 2101, an input operation performed by a user with an electronic pen on the dynamic 2D map is received. At step 2102, the elapsed time from the point in time at which the input operation with an electronic pen is received is calculated based on a timer (not shown schematically) included within the image processing apparatus 100. At step 2103, while displaying the locus of the input operation by a user with an electronic pen (in the examples in FIG. 17C and FIG. 17D described previously, broken line arrows), the dynamic 2D map is advanced by the number of frames corresponding to the calculated elapsed time. At this time, by adjusting the adjustment bar 1402, it is possible to adjust to which extent the dynamic 2D map is advanced for the calculated elapsed time. For example, in a case where the reproduction speed is halved by the adjustment bar 1402, it is possible to perform slow reproduction in which the moving image is advanced 2.5 seconds for the calculated elapsed time, that is, five seconds, of the electronic pen input. The locus of the input operation with an electronic pen, which is displayed on the dynamic 2D map as describe above, is the gaze point path. At step 2104, whether the gaze point path specification has been performed for the entire set time frame is determined. In a case where there is an unprocessed frame, the processing returns to step 2102 and the processing is repeated. On the other hand, in a case where the gaze point path specification has been completed for the entire target time frame, this processing is exited. The above is the contents of the gaze point path specification reception processing in the case of “Time-sync”.

Following the above, the case of “Pen-sync” is explained along the flow in FIG. 21B. At step 2111, an input operation performed by a user with an electronic pen on the dynamic 2D map is received. At step 2112, an accumulated value of the length of the locus of an electronic pen (accumulated locus length) from the point in time at which the input operation with an electronic pen is received is calculated. At step 2113, while displaying the locus of the input operation with an electronic pen, the dynamic 2D map is advanced by the number of frames corresponding to the calculated accumulated locus length. For example, in a case where the accumulated locus length is represented by the equivalent number of pixels on the dynamic 2D map, an example is considered in which the moving image advances by one frame for one pixel of the accumulated locus length. Further, at this time, in a case where the reproduction speed is halved by adjusting the adjustment bar 1402, it is possible to perform slow reproduction in which the moving image is advanced by one frame for two pixels of the accumulated locus length. At step 2114, whether the gaze point path specification has been performed for the entire set time frame is determined. In a case where there is an unprocessed frame, the processing returns to step 2112 and the processing is repeated. On the other hand, in a case where the gaze point path specification has been completed for the entire target time frame, this processing is exited. The above is the contents of the gaze point path specification reception processing in the case of “Pen-sync”.

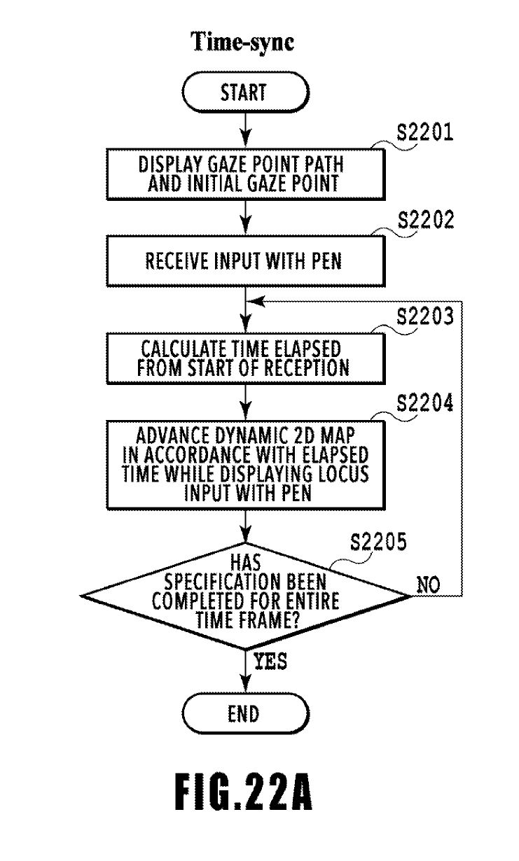

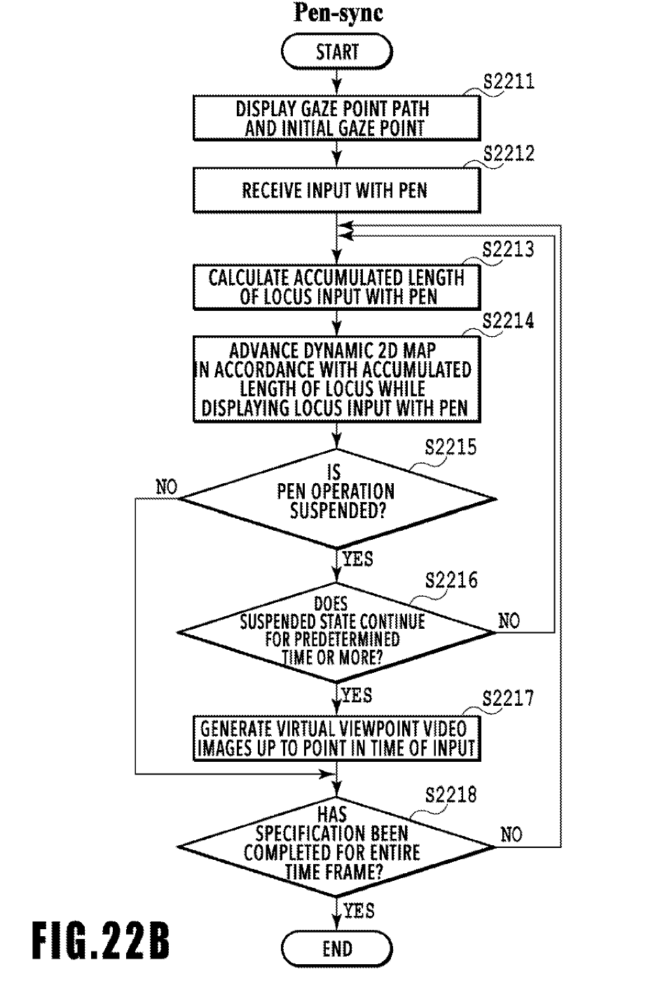

FIG. 22A is a flowchart showing details of the camera path specification reception processing in the case of “Time-sync” and FIG. 22B is that in the case of “Pen-sync”. As described previously, this processing starts by a user pressing down the Camera path specification button 1422.

First, the case of “Time-sync” is explained along the flow in FIG. 22A. At step 2201, the gaze point path specified at step 1604 described previously and the start point (initial gaze point) on the gaze point path are displayed on the dynamic 2D map. In the examples in FIG. 18A to FIG. 18C, the gaze point path is the broken line arrow 1701 and the initial gaze point is the x mark 1800. At step 2202, an input operation performed by a user with an electronic pen on the dynamic 2D map is received. At step 2203, as in the case with step 2102 described previously, the elapsed time from the point in time at which the input operation with an electronic pen is received is calculated. At step 2204, while displaying the locus of the received input operation with an electronic pen in such a manner that the locus is not confused with the gaze point path (for example, the kind of line or color is changed or the like), the dynamic 2D map is advanced by the number of frames corresponding to the calculated elapsed time. At this time, the current position of the gaze point also moves in accordance with the elapse of time. In this manner, the locus of the input operation with an electronic pen is displayed as a camera path. In the examples in FIG. 18B and FIG. 18C described previously, by indicating the camera path by the solid line arrow 1801, the camera path is distinguished from the gaze point path indicated by the broken line arrow 1701. At step 2205, whether the camera path specification has been performed for the entire set time frame is determined. In a case where there is an unprocessed frame, the processing returns to step 2203 and the processing is repeated. On the other hand, in a case where the camera path specification has been completed for the entire target time frame, this processing is exited. The above is the contents of the camera path specification reception processing in the case of “Time-sync”.

Following the above, the case of “Pen-sync” is explained along the flow in FIG. 22B. At step 2211, the gaze point path specified at step 1604 described previously and the initial gaze point of the gaze point path are displayed on the dynamic 2D map. At step 2212, an input operation performed by a user with an electronic pen on the dynamic 2D map is received. At step 2213, the accumulated value of the length of the locus of an electronic pen (accumulated locus length) from the point in time at which the input operation with an electronic pen is received is calculated. At step 2214, while displaying the locus of the input operation with an electronic pen in such a manner that the locus is not confused with the gaze point path (for example, the kind of line or color is changed or the like), the dynamic 2D map is advanced by the number of frames corresponding to the calculated accumulated locus length. At this time, the current position of the gaze point also moves in accordance with the advance of the dynamic 2D map. In this manner, the locus of the input operation with an electronic pen is displayed as a camera path. At step 2215, whether the input operation with an electronic pen is suspended is determined. For example, the position coordinates of the electronic pen are compared between the current frame and the immediately previous frame and in a case where there is no change, it is determined that the input operation with the electronic pen is suspended. In a case where the results of the determination indicate that the input operation with the electronic pen is suspended, the processing advances to step 2216 and in a case where the input operation with the electronic pen is not suspended, the processing advances to step 2217. At step 2216, whether the state where the input operation with the electronic pen is suspended continues for a predetermined time, for example, five seconds or the like, or more is determined. In a case where the results of the determination indicate that the suspended state continues for a predetermined time or more, the processing advances to step 2217 and in a case where the suspended state does not continue for a predetermined time or more, the processing returns to step 2213 and the processing is continued. At step 2217, generation of virtual viewpoint video images up to the point in time at which the input operation with the electronic pen is performed is performed before step 1505 in the flow in FIG. 15 is reached. At this time, generation of virtual viewpoint video images is performed in accordance with the camera path corresponding to the locus for which the input operation has been completed. The reason is to effectively make use of the unused time of resources. At step 2218, whether the specification of a camera path has been performed for the entire set time frame is determined. In a case where there is an unprocessed frame, the processing returns to step 2213 and the processing is repeated. On the other hand, in a case where the specification of a camera path has been completed for the entire target time frame, this processing is exited. The above is the contents of the camera path specification reception processing in the case of “Pen-sync”.

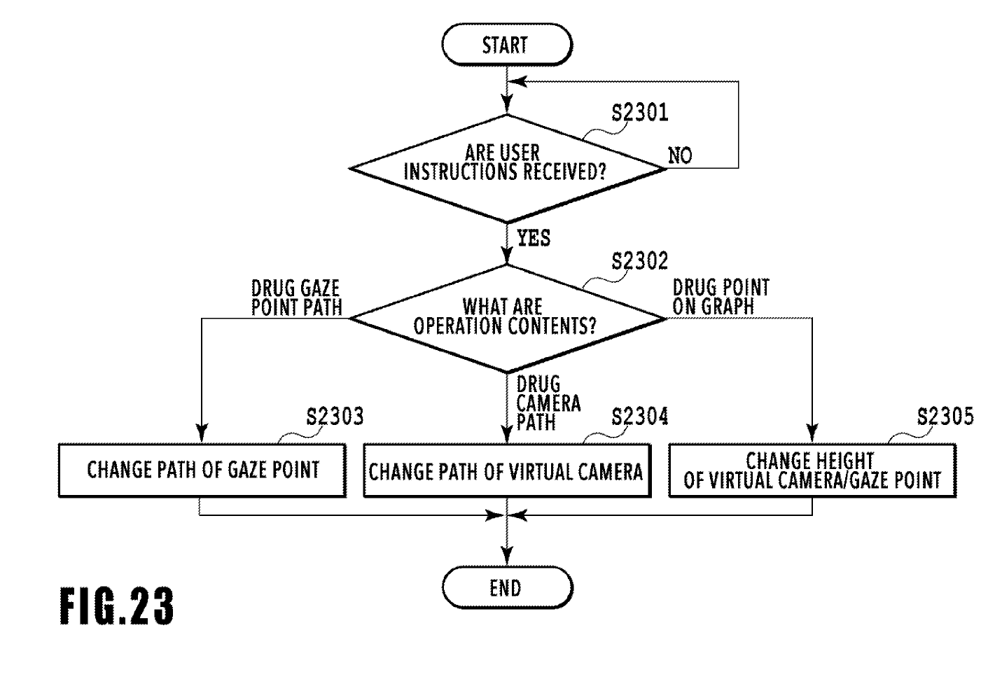

Following the above, the path adjustment processing according to the present embodiment is explained. FIG. 23 is a flowchart showing details of the path adjustment processing of the present embodiment. As described previously, this processing starts by a user selecting a gaze point path or a camera path on the dynamic 2D map or a point on the graph 1425. In a case where the dropdown list 1426 at the time of selecting a point on the graph 1425 is “Camera”, the path adjustment processing is for a camera path and in a case where the dropdown list 1426 is “Point of Interest”, the path adjustment processing is for a gaze point path.

At step 2301, whether user instructions are given to a camera path, or a gaze point path, or a point on the graph 1425, which relates to the user selection, is determined. In the present embodiment, in a case where the input operation with an electronic pen is detected, it is determined that user instructions are given and the processing advances to step 2302.

At step 2302, the processing is branched in accordance with the contents of the user instructions. In a case where the user instructions are the drug operation for a gaze point path, the processing advances to step 2303, in a case where the user instructions are the drug operation for a camera path, the processing advances to step 2304, and in a case where the user instructions are the drug operation for a point on the graph 1425, the processing advances to step 2305, respectively.

At step 2303, in accordance with the movement of the gaze point path by the drug operation, the movement path of the gaze point is changed. Here, it is assumed that the path specification mode is “Time-sync”. In this case, on a condition that a user selects an arbitrary midpoint on the gaze point path, the movement path is changed along the movement destination while maintaining the start point and the endpoint thereof. At this time, processing, such as spline interpolation, is performed so that the gaze point path after the change becomes smooth. On the other hand, in a case where a user selects the start point or the endpoint of the gaze point path, the length of the gaze point path is increased or decreased in accordance with the movement destination. At this time, the case where the length of the gaze point path increases means that the moving speed of the gaze point increases and on the contrary, the case where the length decreases means that the moving speed of the gaze point decreases. The case where the path specification mode is “Pen-sync” is basically the same, but it is not possible to make adjustment, such as adjustment to change the length of the gaze point path. The reason is that in “Pen-sync”, the path length is equal to the reproduction time. The adjustment of the moving speed of the gaze point in the case of “Pen-sync” is made by the adjustment bar 1402 for adjusting the reproduction speed of the dynamic 2D map.

At step 2304, in accordance with the movement of the camera path by the drug operation, the movement path of the virtual camera is changed. The contents thereof are the same as those of the path change of the gaze point path described previously, and therefore, explanation is omitted. At step 2305, in accordance with the movement of the point on the graph by the drug operation, the height of the virtual camera is changed in a case where “Camera” is selected, and the height of the gaze point is changed in a case where “Point of Interest” is selected in accordance with the position of the point of the movement destination. The above is the contents of the path adjustment processing according to the present embodiment.

According to the present embodiment, in addition to the effect of the first embodiment, there are advantages as follows. First, the preprocessing for virtual camera setting (estimation of the position and three-dimensional shape of an object) is not necessary, and therefore, the processing load is light and it is possible to start the setting of a camera path or a gaze point path earlier. Further, no thumbnail image is used, and therefore, the screen at the time of specifying the movement path of a virtual camera or the like is simple and the object becomes easier to see. Furthermore, the movement path of a virtual camera or the like is specified in accordance with the progress of the moving image, and therefore, it is easy to grasp the movement of the object and estimation is easy. By these effects, the user interface becomes one easier for a user to use.

### Other Embodiments

It is also possible to implement the present invention by processing to supply a program that implements one or more functions of the above-described embodiments to a system or an apparatus via a network or a storage medium and to cause one or more processors in a computer of the system or the apparatus to read and execute the program. Further, it is also possible to implement the present invention by a circuit (for example, ASIC) that implements one or more functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

As above, the present invention is explained with reference to the embodiments, but it is needless to say that the present invention is not limited to the above-described embodiments. The scope of the following claims is to be accorded the broadest interpretation so as to encompass all such modifications and equivalent structures and functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus that sets a movement path of a virtual viewpoint relating to a virtual viewpoint image generated based on a plurality of images obtained by a plurality of cameras, the information processing apparatus comprising:
a specification unit configured to specify a movement path of a virtual viewpoint;
a display control unit configured to display a plurality of virtual viewpoint images in accordance with the movement path specified by the specification unit on a display screen;
a reception unit configured to receive an operation for at least one of the plurality of virtual viewpoint images displayed on the display screen; and
a change unit configured to change the movement path specified by the specification unit in accordance with the operation received by the reception unit.

2. The information processing apparatus according to claim 1, wherein
the display control unit determines the number of virtual viewpoint images to be displayed on the display screen so that the plurality of virtual viewpoint images does not overlap one another on the display screen.

3. The information processing apparatus according to claim 1, wherein
the display control unit reduces, in a case where two or more virtual viewpoint images overlap one another on the display screen on a condition that the plurality of virtual viewpoint images is displayed at predetermined intervals of the movement path, the number of virtual viewpoint images to be displayed on the display screen.

4. The information processing apparatus according to claim 1, wherein
the display control unit displays more virtual viewpoint images in a predetermined range from at least one of a start point and an endpoint of the movement path than those in another portion on the movement path.

5. The information processing apparatus according to claim 1, wherein
the display control unit displays more virtual viewpoint images in a predetermined range from a point at which a change in virtual viewpoint is large of the movement path than those in another portion on the movement path.

6. The information processing apparatus according to claim 1, wherein
the display control unit determines a display position on the display screen of each of the plurality of virtual viewpoint images so that the plurality of virtual viewpoint images does not overlap one another on the display screen.

7. The information processing apparatus according to claim 1, wherein
in a case where the reception unit receives a movement operation of the virtual viewpoint image, the change unit changes a shape of the movement path based on a position after the movement by the movement operation of the virtual viewpoint image.

8. The information processing apparatus according to claim 1, wherein
in a case where the reception unit receives a size change operation of the virtual viewpoint image, the change unit changes a height of a virtual viewpoint on the movement path based on a size after the change by the size change operation of the virtual viewpoint image.

9. The information processing apparatus according to claim 1, wherein
in a case where the reception unit receives a predetermined user operation for the virtual viewpoint image, the change unit changes a moving speed of a virtual viewpoint during a period of time specified based on a virtual viewpoint image corresponding to the predetermined user operation of the movement path.

10. A method of setting a movement path of a virtual viewpoint relating to a virtual viewpoint image generated based on a plurality of images obtained by a plurality of cameras, the method comprising the steps of:
specifying a movement path of a virtual viewpoint;
displaying a plurality of virtual viewpoint images in accordance with the specified movement path on a display screen;
receiving an operation for at least one of the plurality of virtual viewpoint images displayed on the display screen; and
changing the specified movement path in accordance with reception of the operation for the virtual viewpoint image.

11. A non-transitory computer readable storage medium storing a program for causing a computer to perform a method of setting a movement path of a virtual viewpoint relating to a virtual viewpoint image generated based on a plurality of images obtained by a plurality of cameras, the method comprising the steps of:
specifying a movement path of a virtual viewpoint;
displaying a plurality of virtual viewpoint images in accordance with the specified movement path on a display screen;
receiving an operation for at least one of the plurality of virtual viewpoint images displayed on the display screen; and
changing the specified movement path in accordance with reception of the operation for the virtual viewpoint image.
